(19) United States
(12) Patent Application Publication
(10) Pub. No.: US 2026/0289625 A1
(43) Pub. Date: Sep. 24, 2026

(54) SYSTEM

(71) Applicant: SoftBank Group Corp., Tokyo (JP)

(72) Inventor: Natsumi MIYAZAKI, Tokyo (JP)

(73) Assignee: SoftBank Group Corp., Tokyo (JP)

(21) Appl. No.: 19/562,908

(22) Filed: Mar. 11, 2026

(30) Foreign Application Priority Data
Mar. 19, 2025 (JP) 2025-044972

(51) Int. Cl. G06Q 30/0601

(52) U.S. Cl. CPC G06Q 30/0623

(57) ABSTRACT

A system includes a processor configured to: acquire current temperature and weather information via a sensor device and propose clothing coordination based thereon; store user-owned clothing items in a database and propose optimal clothing coordination therefrom using a generative AI model; filter product information from online shopping sites based on user preferences and style and propose appropriate clothing based on the filtering results; acquire user emotion via a camera and/or microphone, analyze the acquired emotion using an emotion analysis algorithm, and adjust clothing proposals based on the analysis; and generate, using the generative AI model, a prompt sentence corresponding to user input and/or detected emotion, and propose optimal clothing based on the generated prompt sentence.

### CROSS-REFERENCE TO RELATED APPLICATION

This application is based on and claims priority under 35 USC 119 from Japanese Patent Application No. 2025-044972 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional clothing recommendation systems typically rely on limited information, such as static user profiles, simple preference settings, or manually selected categories, and thus fail to provide highly personalized and context-aware outfit proposals. Such systems generally do not comprehensively consider real-time environmental factors, including the current temperature and weather at the user's location, and therefore cannot adequately propose clothing coordinated to daily conditions. Moreover, known systems often treat the user's owned wardrobe, online shopping items, and emotional state as independent elements, resulting in fragmented experiences where recommendations are either disconnected from the user's existing clothing items or from the user's real-time mood and intentions.

In addition, many recommendation engines rely primarily on simple filtering or collaborative filtering based on purchase history, without effectively leveraging generative artificial intelligence models that can create nuanced proposals and explanation texts tailored to the user's inputs and emotions. Existing systems also lack robust mechanisms for integrating sensor devices, such as cameras, microphones, and other environmental sensors, with emotion analysis algorithms and data mining techniques. As a result, they are unable to dynamically adjust clothing proposals in response to subtle emotional changes or combined contextual factors such as current weather, wardrobe status, and online product availability.

Therefore, there is a need for a system that can: (i) acquire and utilize real-time temperature and weather information through sensor devices; (ii) manage and exploit a database of clothing items owned by the user; (iii) filter and select products from online shopping sites according to the user's preferences and style; (iv) detect and analyze the user's emotional state through cameras and microphones; and (v) employ generative artificial intelligence models to generate prompts and clothing proposals that reflect both the user's inputs and emotional condition. The objective of the present invention is to provide such an integrated, context-aware clothing recommendation system that delivers highly personalized and adaptive outfit proposals.

### SUMMARY

To solve the above-described problems, the invention provides a system comprising a processor, wherein the processor is configured to execute a set of coordinated functions that integrate environmental sensing, wardrobe management, online product selection, emotion analysis, and generative artificial intelligence.

According to one aspect of the invention, the processor is configured to acquire, by using a sensor device, information regarding a current temperature and weather of a user, and to propose a clothing coordination based on the acquired temperature and weather. By directly linking sensed environmental data to coordination logic, the system can generate outfits that are appropriate for the day's conditions, such as rain, cold, heat, or other weather variations.

According to another aspect of the invention, the processor is configured to store, in a database, clothing items owned by the user, and to propose an optimal clothing coordination based on the stored clothing items by using a generative artificial intelligence model. The processor can reference the user's wardrobe database to ensure that proposed outfits can be realized with items that the user actually possesses, while the generative artificial intelligence model composes tailored coordination suggestions and explanation texts based on those items.

According to still another aspect, the processor is configured to filter product information acquired from an online shopping site based on a preference and a style of the user, and to propose appropriate clothing based on a result of the filtering. Furthermore, the processor is configured to analyze past purchase history and browsing history of the user by using a data mining technique, and to select a clothing proposal from the online shopping site based on the preference and the style of the user. In this way, the system can propose new items that not only complement the user's owned wardrobe but also match the user's established tastes and purchasing behavior.

In addition, the processor is configured to acquire an emotion of the user by using at least one of a camera and a microphone, to analyze the acquired emotion by using an emotion analysis algorithm, and to adjust a clothing proposal based on a result of the analysis. The processor is also configured to receive an input from the user via an interface, to store input information corresponding to the input in the database, and to make a proposal that takes into account the emotion of the user by using an emotion engine. Thus, the system can adapt its clothing recommendations in real time based on the user's emotional state, such as happiness, stress, or fatigue, and can provide more empathetic and psychologically aligned suggestions.

Further, the processor is configured to generate, by using the generative artificial intelligence model, a prompt sentence corresponding to at least one of an input from the user and the emotion of the user, and to propose optimal clothing based on the generated prompt sentence.

By dynamically generating internal prompts that reflect both user-provided information and emotional context, the system can control the generative artificial intelligence model to output highly personalized, context-aware clothing proposals. Through these combined means, the invention achieves an integrated clothing coordination system that addresses the limitations of conventional systems and provides sophisticated, adaptive, and user-centric outfit recommendations.

The term “processor” refers to a hardware device or a combination of hardware and software components, such as a CPU, GPU, microcontroller, or computing unit, configured to execute instructions and perform the operations described in the claims.

The term “sensor device” refers to any device or combination of devices capable of detecting and outputting information related to environmental or user conditions, including but not limited to temperature sensors, weather sensors, GPS modules, barometric sensors, smartphones equipped with such sensors, or remote weather information acquisition modules.

The term “current temperature and weather” refers to environmental conditions at or near the user's present location, including at least ambient temperature and weather state (such as sunny, cloudy, rainy, or snowy), which are used as inputs for generating clothing coordination proposals.

The term “clothing coordination” refers to a combination or arrangement of one or more clothing items, accessories, or footwear proposed to the user as an outfit suitable for given conditions, preferences, or emotional states.

The term “database” refers to any structured data storage system, including relational databases, non-relational databases, or other memory structures, configured to store and manage data such as clothing items, user profiles, purchase histories, browsing histories, and user inputs.

The term “clothing items owned by the user” refers to articles of clothing, accessories, or footwear that the user possesses and that are registered or stored as records in the database.

The term “generative artificial intelligence model” refers to an artificial intelligence model, such as a neural network-based language model or multimodal model, that is configured to generate outputs, including text, prompts, or recommendations, based on input data or instructions.

The term “product information acquired from an online shopping site” refers to data obtained from one or more e-commerce platforms, including at least product identifiers, names, categories, descriptions, images, tags, and optional pricing or availability information related to clothing or fashion items.

The term “preference and style of the user” refers to characteristics representing the user's tastes and fashion tendencies, including preferred colors, categories, brands, formality levels, or style tags (such as casual, formal, minimal, or street), derived from explicit user settings, historical behavior, or analytical inference.

The term “filtering” refers to a processing operation in which a set of product information is evaluated according to one or more criteria, such as user preferences or styles, and a subset of products satisfying the criteria is selected.

The term “emotion of the user” refers to an affective or psychological state of the user, such as happiness, sadness, stress, calmness, excitement, or fatigue, which is estimated based on signals acquired from devices including cameras and microphones.

The term “camera” refers to an optical sensing device, such as a digital camera or webcam integrated into or connected to a terminal, that captures still images or video of the user or surroundings for use in emotion analysis or related processing.

The term “microphone” refers to an audio sensing device, such as a built-in or external microphone, that captures sound, including the user's voice or ambient audio, for use in emotion analysis or related processing.

The term “emotion analysis algorithm” refers to a software-implemented procedure or model configured to estimate the emotional state of the user from input signals, such as facial images, voice features, or other sensor data, using techniques including pattern recognition, machine learning, or neural networks.

The term “emotion engine” refers to a software module or combination of software and models that uses outputs of the emotion analysis algorithm to influence or generate proposals, responses, or recommendations that take into account the estimated emotional state of the user.

The term “prompt sentence” refers to a text or structured input generated for or used by the generative artificial intelligence model, which encodes conditions, context, or instructions, including at least user inputs and emotional states, to guide the generation of clothing proposals or related outputs.

The term “user input” refers to information provided directly by the user through an interface, including natural language text, selections, preferences, or other commands, that is processed by the system to generate proposals or update stored data.

The term “interface” refers to any user interaction mechanism, including graphical user interfaces, chat interfaces, voice interfaces, or input forms, that enables the user to provide input to the system and receive output from the system.

The term “past purchase history and browsing history of the user” refers to records of products previously purchased or viewed by the user on one or more online shopping sites, including product identifiers, timestamps, and associated attributes, which are used for analysis of preferences and style.

The term “data mining technique” refers to a computational method or set of methods, including statistical analysis, clustering, classification, association rule mining, or machine learning, that is applied to large or complex datasets, such as purchase and browsing histories, to discover patterns or infer user preferences and styles.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

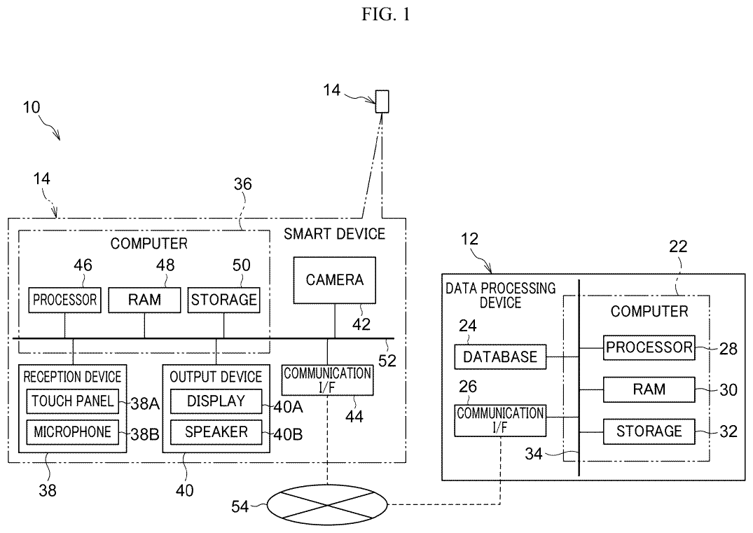

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

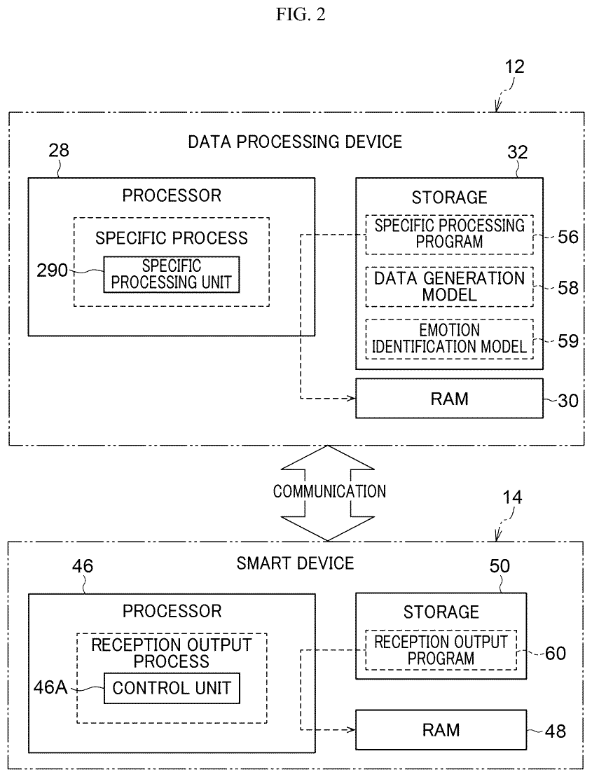

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional outfit recommendation systems typically treat environmental conditions, user inventory information, and online product information as independent data streams that are processed by fixed, rule-based logic. Such systems often rely on static decision trees or simple filtering pipelines that do not fully exploit current advances in generative AI models and natural language interfaces. As a result, these systems tend to generate coarse, repetitive, or context-insensitive recommendations that are poorly adapted to rapidly changing meteorological conditions, heterogeneous user wardrobes, and diverse commercial offerings.

Furthermore, existing systems generally lack a structured mechanism for transforming heterogeneous low-level data (for example, raw weather API outputs, wardrobe records, and e-commerce catalog data) into unified prompt sentences optimized for consumption by a generative AI model. Without such a mechanism, the generative AI model cannot reliably interpret the overall situational context, which leads to unstable outputs and inconsistent user experience. From the viewpoint of computer technology, this results in inefficient use of computational resources on both the application server and the generative AI infrastructure, because multiple trial-and-error calls to the model are often required to obtain acceptable results.

In addition, conventional systems capture user behavior (such as purchase history and browsing history) and emotional state, if at all, in ad hoc ways that are not tightly integrated into the data path that constructs input to generative AI models. This lack of integration means that important personalization signals are not systematically reflected in the formation of prompt sentences. Consequently, the system cannot effectively adapt ranking and selection of candidate items, and cannot dynamically refine its own prompt construction strategy based on accumulated interaction logs. This prevents the system from improving its performance over time in a principled, machine-driven manner.

There is therefore a need for an improved computer-implemented system that: (i) normalizes and fuses meteorological data, wardrobe data, behavior history data, and commercial product data into a structured internal representation; (ii) programmatically generates context-rich prompt sentences for a generative AI model so that the model can produce stable and high-quality natural-language proposals; and (iii) automatically updates the configuration of prompt elements and product selection conditions by learning from user feedback and past interactions. Addressing these issues constitutes an improvement in computer-centric data processing architecture for AI-assisted recommendation, rather than a mere automation of human stylist behavior.

The specific processing by the specific processing unit 290 of the data processing device 12 in Example 1 is realized by the following means.

The present invention provides a server comprising a processor configured to acquire current meteorological information from an external meteorological information providing apparatus based on input information including user location received from a user terminal, normalize the meteorological information as meteorological condition data, generate a structured prompt sentence by combining a summary of the meteorological condition data with a user inquiry and with explicit response and constraint conditions, input the prompt sentence into a natural language generative information processing model and obtain natural language output text representing a clothing proposal, store and manage structured attribute data for user-owned garments and accessories in association with user identification information, embed the structured attribute data into the prompt sentence so as to cause the natural language generative information processing model to generate coordination proposals constrained to the stored garments and accessories, select and summarize commercial product data obtained from a commercial transaction information processing apparatus based on generalized attribute information and embed the summarized product data into the prompt sentence so as to cause the natural language generative information processing model to generate purchase candidate proposals, parse the natural language output text to extract proposed items and format output data for presentation at the user terminal, and analyze user additional input, inquiry history, owned garment information, and product selection history to update configuration elements of the prompt sentence and selection conditions for the commercial product data. This enables a computer-centric recommendation architecture in which heterogeneous environmental, user, and commercial data are algorithmically fused into optimized prompt sentences for a generative AI model, thereby improving the technical efficiency, stability, and personalization quality of AI-based outfit recommendations executed by the server.

The term “meteorological information” refers to data indicating environmental conditions at a given place and time, including at least temperature, precipitation, humidity, wind speed, and related weather parameters, acquired from an external information providing apparatus.

The term “meteorological condition data” refers to normalized and structured meteorological information obtained by transforming raw weather data into a standardized internal representation suitable for programmatic processing and prompt generation.

The term “meteorological information providing apparatus” refers to an external information processing apparatus or service that supplies meteorological information via a communication interface in response to a query including location information or a similar parameter.

The term “user terminal” refers to an information processing apparatus operated by a user, such as a computing device having an input/output interface and a communication interface, configured to transmit input information to a server and receive output information from the server.

The term “input information” refers to data transmitted from the user terminal to the server, including at least a user inquiry, user location information, and optionally user identification information or other context information.

The term “user inquiry” refers to natural language text or equivalent information entered by the user via the user terminal, requesting advice or proposals concerning clothing, coordination, or related topics.

The term “location information” refers to data that identifies a geographic position associated with the user, including at least one of coordinates, region identifiers, or address information, suitable for querying meteorological information.

The term “user attribute information” refers to data representing characteristics of the user or usage context, including at least preferences, style tendencies, demographic attributes, and interaction history attributes used to personalize proposals.

The term “natural language generative information processing model” refers to a software-implemented model based on machine learning that receives text input and generates text output in natural language, and that is configured to interpret prompt sentences and produce clothing-related proposals.

The term “generative AI model” refers to a natural language generative information processing model that employs statistical or machine learning techniques to generate new text data responsive to an input prompt.

The term “prompt sentence” refers to a structured text sequence supplied as input to the generative AI model, containing at least a description of meteorological conditions, a user inquiry, and one or more constraint or response conditions, and optionally including wardrobe data or product data.

The term “generation text” refers to the complete text content of a prompt sentence that is constructed for input to the generative AI model, including all contextual descriptions, constraints, and instructions.

The term “response conditions” refers to explicit instructions or requirements included in the prompt sentence, specifying at least a desired style of response, content scope, or format for the output generated by the generative AI model.

The term “constraint conditions” refers to limitations or rules included in the prompt sentence that restrict the generative AI model's output to certain items, sources, styles, or other defined conditions.

The term “garments” refers to wearable items such as tops, bottoms, outerwear, footwear, and similar clothing articles.

The term “accessories” refers to wearable supplementary items such as bags, hats, scarves, jewelry, and similar adornments that can be combined with garments in an outfit.

The term “attribute information” refers to data describing properties of garments or accessories, including at least type, color, material, seasonal suitability, size, functional features, and usage or selection history.

The term “structured data” refers to data that is organized in a predefined schema or format, such as records or fields in a database, enabling deterministic access to attributes associated with garments, accessories, or products.

The term “storage apparatus” refers to a hardware or software-based storage subsystem, such as a memory device or database system, configured to store and manage structured data under control of the processor.

The term “user identification information” refers to data used to uniquely or pseudo-uniquely identify a user or user account within the system, including at least identifiers such as user IDs, account IDs, or equivalent tokens.

The term “coordination proposal” refers to an arrangement of one or more garments and accessories recommended as an outfit suitable for specific conditions, generated by the generative AI model or derived from its output.

The term “commercial transaction information processing apparatus” refers to an external system or service that maintains product data for goods or services and provides such data in response to search or query requests, including but not limited to commerce platforms.

The term “product data” refers to structured information representing commercial items, including at least product identifiers, descriptive attributes, price information, availability, and optionally links or media references.

The term “generalized attribute information” refers to product attribute data normalized into categories such as price range, functional characteristics, color classification, style classification, and size classification for use in algorithmic selection and filtering.

The term “purchase candidate proposal” refers to a set of recommended commercial items, and associated explanation text, generated in view of user preferences, wardrobe context, and meteorological conditions.

The term “output data” refers to data formatted by the processor for transmission to the user terminal, including at least natural language recommendation text and optionally structured representations of proposed garments, coordination proposals, or product candidates.

The term “behavior history data” refers to data representing past user actions, including at least purchase history information, browsing history information, selection behavior, and interaction logs with the system.

The term “preference parameters” refers to numerical or categorical values derived from behavior history data or other sources, representing estimated user likes, dislikes, or tendencies used to control selection and ranking of items or proposals.

The term “emotion information estimation processing” refers to processing that infers a user's emotional state from input such as text content or other signals, using at least one of rule-based methods, statistical methods, or machine learning models.

The term “emotion state data” refers to structured data representing an inferred emotional condition of the user, such as calm, stressed, excited, or other emotional categories or scores, suitable for inclusion in a prompt sentence.

The term “configuration elements of the prompt sentence” refers to constituent components of the prompt sentence, including at least meteorological description segments, wardrobe description segments, product description segments, constraint statements, and response instruction segments.

The term “selection conditions for the product data” refers to criteria or rules used by the processor to filter and rank product data, including at least conditions derived from meteorological conditions, user preferences, wardrobe gaps, and system objectives.

In one embodiment, a server cooperates with a terminal operated by a user to provide context-aware clothing coordination proposals. The server includes at least one processor, a main memory, a persistent storage apparatus such as a relational database, and a communication interface connected to a packet-switched network. The terminal includes an input/output interface, a display unit, a communication module, and, in some cases, a position detecting module. The user operates the terminal to input natural language inquiries and optional preference information.

The terminal executes an application, such as a web browser application or a native mobile application, which is implemented using standard operating system APIs. The terminal presents a chat-style interface that allows the user to input free-form text such as “It is going to rain today, what should I wear?” and to grant permission for use of location information. The terminal acquires location information from a location acquisition subsystem, for example a global positioning system module or a network-based location service, and transmits the location information together with the text inquiry to the server via a secure communication protocol.

The server receives input information from the terminal using a web application framework, for example a server program running on a general-purpose computing platform with a Unix-like operating system. The server parses the incoming data stream using a communication library and stores the text inquiry, location information, and a user identifier in a database management system, such as a relational database engine. The database stores the data in structured records that include at least fields for a user identifier, timestamp, inquiry text, location coordinates, and processing status.

The server uses the location information as input to a meteorological information providing apparatus, such as a weather data service accessed via an application programming interface.

The server constructs a query message that encodes geographic coordinates and, in some embodiments, time-of-day and unit preferences. The server transmits the query message using an HTTP client library and receives meteorological information in a structured format, such as a JSON object containing fields for temperature, precipitation conditions, humidity, wind speed, and descriptive weather codes.

The server converts the meteorological information into meteorological condition data by executing normalization logic. The server maps numeric values, such as temperature and humidity, into normalized ranges, and converts units when necessary, for example, converting Kelvin-based temperature values into Celsius values by applying arithmetic operations. The server also maps descriptive weather codes into categorical labels, such as “rainy,” “clear,” “cloudy,” or “snowy,” using a lookup table stored in memory. The server produces a compact internal representation that includes normalized temperature, precipitation flag, humidity range, wind speed range, and weather category, which is stored as a record in memory and associated with the corresponding user inquiry.

The server stores attribute information for garments and accessories owned by the user in the database. The user registers individual items by operating the terminal to input item descriptions, such as “black waterproof jacket,” “gray cotton hoodie,” and “white sneakers.”

The terminal transmits structured wardrobe data that includes fields such as type, color, material, season, and optional tags. The server receives the wardrobe data, validates attribute values, and writes them into a wardrobe table in the database. Each wardrobe item is associated with the user identifier and may include additional fields such as usage frequency, last worn date, and suitability flags for particular weather conditions.

The server acquires commercial product data from an external commercial transaction information processing apparatus. The server transmits query messages that specify generalized attribute information, such as price range, category, color family, style attribute, and size attribute, and receives product data including product identifiers, attribute fields, price information, and links. The server stores the product data in a product catalog table or in a cache structure, along with derived features such as a normalized price segment and style classification labels.

The server constructs a prompt sentence for a generative AI model by combining multiple structured components. The server generates a meteorological description text based on the meteorological condition data, for example, “The current weather at the user's location is rainy with a temperature of 15° C. and high humidity.” The server appends the user inquiry, for example, “The user asks: ‘It is going to rain today; what should I wear?’” The server then appends additional constraint and response instructions, for example, “Suggest clothing that is suitable for this weather. Provide concise recommendations in English.”

In a wardrobe-constrained scenario, the server further retrieves the user's wardrobe items from the database and serializes them into a structured but human-readable list. The server constructs a segment such as:

“The user owns the following clothing items:
1) black waterproof jacket
2) gray cotton hoodie
3) white T-shirt
4) bluejeans
5) black leather boots.”

The server inserts this list into the prompt sentence and adds an explicit constraint, such as “Create a coordinated outfit using only these items, and explain briefly why it is suitable.”

In an example, the server generates a prompt sentence in the following form:

“The current weather at the user's location is cold (about 6° C.), windy, and clear this evening.

The user is going to a casual dinner.

The user owns the following clothing items:
1) black down jacket
2) navy hoodie
3) white T-shirt
4) bluejeans
5) black leather boots
6) gray beanie

Based on the weather and the user's plan, recommend a coordinated outfit using only these items. Explain briefly why this outfit is suitable for a cold, windy evening and a casual dinner.

Answer in concise English.”

The server uses a generative AI model implemented as a neural network-based natural language processing system. In one embodiment, the generative AI model is a transformer-based neural network that includes a plurality of self-attention layers, feed-forward layers, and normalization layers. The generative AI model is trained on large-scale text corpora using an unsupervised learning objective such as next-token prediction. During training, the model receives input token sequences and computes output probability distributions over a vocabulary using softmax layers. The training process minimizes a loss function, for example a cross-entropy loss between predicted token distributions and ground truth tokens, using gradient-based optimization such as stochastic gradient descent or adaptive gradient algorithms. Model parameters, including weights in attention matrices and feed-forward networks, are updated by backpropagation using computed gradients. The generative AI model may use subword tokenization schemes, attention masks, and positional encodings.

The server interacts with the generative AI model through an application programming interface. The server converts the prompt sentence into a sequence of tokens using a tokenizer consistent with the model's training configuration. The server sets decoding parameters, such as maximum token count, temperature, top-k or top-p sampling thresholds, and optionally penalty coefficients for repetition. The server transmits the encoded prompt and parameters to the generative AI model and receives one or more candidate output sequences.

The server post-processes the output of the generative AI model by decoding token sequences into natural language text, then performing parsing operations to identify garment names, outfit components, and explanatory sentences. The server may implement rule-based parsing that relies on punctuation and pattern matching, for example detecting list markers or key phrases such as “wear,” “pair with,” and “combine.” In some embodiments, the server applies a secondary classifier, such as a smaller neural network trained to categorize segments into “item” and “explanation” labels, to structure the output for display and logging.

The server maintains configuration elements used to construct prompt sentences. These configuration elements include templates for meteorological description, rules for ordering wardrobe items, patterns for encoding constraints, and phrasing for response instructions. The server updates these configuration elements based on analysis of behavior history data. For example, the server computes preference parameters by applying statistical analysis or a machine learning algorithm, such as a matrix factorization model or a gradient-boosted decision tree, to past purchase history, browsing history, and explicit feedback. The server adjusts selection conditions for product data, such as narrowing or expanding price ranges and changing style filters, and modifies prompt templates, such as emphasizing budget constraints when the user has previously selected lower-priced items.

The server implements emotion information estimation processing to derive emotion state data from user input. The server may run a text-based emotion classifier, implemented as a neural network fine-tuned on labeled emotion data, that maps sentences into emotion labels or scores such as “calm,” “anxious,” or “excited.” The server then incorporates the emotion state data into the prompt sentence as a modifier, for example, “The user appears to be anxious about staying warm and dry; provide reassuring and practical advice.” By embedding these signals into the prompt sentence, the server enables the generative AI model to adjust tone and content in a reproducible manner.

The server constructs different data structures for efficiency. The server may store meteorological condition data as compact numeric arrays indexed by user identifier and timestamp, wardrobe items as relational records with indexed columns for type and season, and product data as objects containing both original attributes and derived normalized attributes.

The server makes use of indexing strategies and caching mechanisms to reduce access latency to frequently requested items. In some embodiments, the server aggregates multiple API calls to meteorological services or commercial transaction apparatuses and caches the results to reduce communication overhead, thus improving throughput and making more efficient use of network and compute resources.

The server provides technical improvements over conventional systems by offloading complex contextual fusion into a structured prompt generation pipeline. The server avoids repeated ad hoc interactions with the generative AI model by constructing prompt sentences that encode meteorological conditions, wardrobe context, product context, preference parameters, and emotion state data in a single coherent sequence. This reduces the number of model invocations required to obtain high-quality proposals, thereby lowering latency and computational cost. The server leverages specific aggregation rules, normalization functions, and selection algorithms that are not merely automating human stylist behavior but instead optimize data representation for machine processing, which leads to stable and reproducible model behavior.

The terminal displays the proposals received from the server using a user interface that can highlight recommended items, indicate which wardrobe elements are used, and present product candidates with images and links. The user can request alternative suggestions, refine constraints, or update wardrobe items, and the terminal transmits such updates to the server for incorporation into subsequent processing. In this way, the system continuously adapts both the data structures and the prompt construction rules.

In another embodiment, the server operates with a local generative AI model deployed within the same computing environment, rather than an external service. The server loads model parameters into memory from storage and performs inference using specialized hardware accelerators such as graphics processing units or tensor processing units. The server may implement quantization or pruning techniques to reduce model size and inference time. The server may also maintain multiple model variants, such as a larger model for comprehensive fashion advice and a smaller model for rapid on-device or near-device inference, and select between them based on system load or user latency requirements.

In an alternative configuration, the server employs a multi-stage pipeline in which a first generative AI model generates candidate outfits while a second evaluation model scores each candidate for consistency with meteorological condition data and wardrobe constraints. The evaluation model operates on feature vectors representing combined item attributes and weather parameters and outputs scores that the server uses to select the highest-ranked recommendations. This architecture further improves proposal reliability and reduces the likelihood of violations of constraints encoded in the prompt sentence.

In all of these embodiments, the server, the terminal, and the user interact in a data flow that is specifically designed to improve computational efficiency, data management, and recommendation quality. The system is not limited to clothing recommendations; the same architecture can be applied to other domains where environmental conditions, owned item inventories, and commercial product catalogs must be combined to generate optimized natural language guidance. The use of structured prompt sentence construction, explicit constraint encoding, and feedback-driven configuration updates provides a reproducible and technically grounded method that can be implemented and executed on standard computer hardware and software architectures.

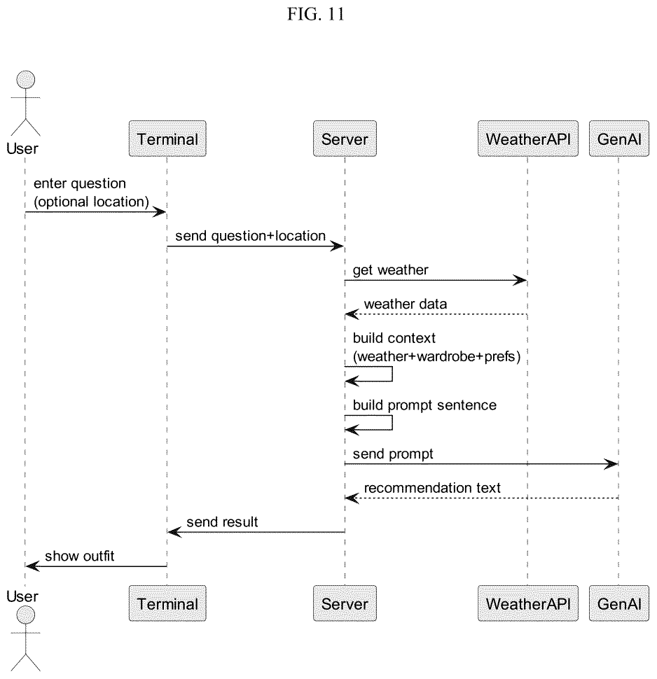

The following describes the processing flow using FIG. 11.

### Step 1:

The user operates the terminal to input a natural language inquiry and optionally grant access to location information. The terminal displays a text input field and a permission dialog for location. The input of this step is user text such as “It is going to rain today; what should I wear?” and, when permitted, raw location data from a positioning module. The terminal converts the user text and location coordinates into an internal data structure, for example a key-value map, and sends this data to the server via a network request.

### Step 2:

The terminal transmits the input information to the server over a communication network. The input of this step is the internal data structure containing at least user text, user identifier, and location information. The terminal serializes this structure into a transmission format, for example a JSON-formatted message, and performs an HTTP POST request to an application endpoint of the server. The output of this step is a network message that reaches the server's communication interface and is ready for parsing.

### Step 3:

The server receives the network message and parses the transmitted data. The input of this step is the serialized message from the terminal. The server uses a communication library to decode the message, extract fields such as inquiry text, user identifier, and coordinates, and verify that mandatory fields are present. The server then stores a record in a logging or database subsystem containing at least the user identifier, timestamp, and inquiry text. The output of this step is an in-memory representation of the user inquiry and associated metadata.

### Step 4:

The server acquires meteorological information from an external meteorological information providing apparatus. The input of this step is the location information and, optionally, time-of-day or user-specified date. The server constructs a query including coordinates and unit parameters and sends it to the external apparatus via an HTTP client. The external apparatus returns raw meteorological information, for example temperature values, weather codes, humidity, and wind data. The output of this step is a structured meteorological response stored in memory.

### Step 5:

The server normalizes the meteorological information into meteorological condition data. The input of this step is the raw meteorological response. The server applies arithmetic operations to convert units, for example converting Kelvin to Celsius by subtracting a constant, and rounds values to a defined precision. The server maps weather codes to human-readable categories using a lookup table and sets flags for precipitation, humidity range, and wind intensity. The output of this step is normalized meteorological condition data, represented as a structured object containing numeric fields and categorical labels.

### Step 6:

The server retrieves stored wardrobe information and preference information for the user. The input of this step is the user identifier obtained earlier. The server executes one or more database queries against tables storing garment attributes, usage history, and style preferences.

The server may filter out inactive items based on status flags or last-used dates. The output of this step is a collection of wardrobe records and preference records loaded into memory as structured data.

### Step 7:

The server optionally acquires commercial product data from a commercial transaction information processing apparatus. The input of this step is a set of selection conditions derived from the meteorological condition data and the user preferences, such as category, price range, style classification, and size constraints. The server forms a query that encodes these conditions and sends it via an HTTP client to the external apparatus. The received product data includes product attributes such as identifiers, descriptions, prices, and style tags. The output of this step is a list of product records stored in memory.

### Step 8:

The server generates a meteorological description text and other context texts. The input of this step is the normalized meteorological condition data, the user inquiry, the wardrobe records, the preference records, and optionally the product records. The server uses conditional logic to construct sentences describing the weather, such as “The current weather at the user's location is rainy with a temperature of 15° C. and high humidity,” and to select which wardrobe items or products to mention. The output of this step is a set of text segments representing weather description, user context, wardrobe summary, and product summary.

### Step 9:

The server constructs a prompt sentence for the generative AI model. The input of this step is the set of text segments generated in Step 8 together with configuration rules and templates.

The server applies string concatenation and template expansion to combine the weather description, the user's inquiry, the wardrobe list, and constraint instructions into a single coherent prompt sentence, for example:

“The current weather at the user's location is cold (about 6° C.), windy, and clear this evening.

The user is going to a casual dinner.

The user owns the following clothing items:
1) black down jacket
2) navy hoodie
3) white T-shirt
4) blue jeans
5) black leather boots
6) gray beanie

Based on the weather and the user's plan, recommend a coordinated outfit using only these items. Explain briefly why this outfit is suitable for a cold, windy evening and a casual dinner. Answer in concise English.”

The output of this step is a finalized prompt sentence ready for input to the generative AI model.

### Step 10:

The server encodes the prompt sentence and sends it to the generative AI model. The input of this step is the prompt sentence and a set of decoding parameters, such as maximum output length and sampling temperature. The server uses a tokenizer to convert the text into token identifiers and packages the tokens and parameters into a request according to the model's application programming interface. The server then transmits this request to the generative AI model host via a communication channel. The output of this step is a model request awaiting processing by the generative AI model.

### Step 11:

The server receives the generated output from the generative AI model and decodes it. The input of this step is the model response, which contains sequences of token identifiers representing the generated text. The server converts token identifiers back into natural language text using the same tokenizer and handles special tokens such as end-of-sequence markers. The output of this step is a raw natural language recommendation text describing a clothing proposal.

### Step 12:

The server parses and structures the generated recommendation text. The input of this step is the raw recommendation text generated in Step 11. The server applies parsing rules, such as splitting by line breaks and punctuation, and pattern matching to detect item descriptions, outfit combinations, and rationale sentences. In some embodiments, the server uses a secondary classifier to label each sentence as an “item recommendation” or “explanation.” The output of this step is a structured representation of the recommendation, including a list of recommended garments and any associated explanations.

### Step 13:

The server formats output data for presentation at the terminal. The input of this step is the structured recommendation, along with the corresponding wardrobe and product references.

The server composes a response object that includes a user-facing text summary and, optionally, structured fields for each recommended wardrobe item and product candidate. The server may also attach identifiers that allow the terminal to link recommendations to underlying items. The output of this step is a formatted response structure ready for transmission to the terminal.

### Step 14:

The server transmits the formatted response to the terminal. The input of this step is the response structure created in Step 13. The server serializes the structure into a message format, such as JSON, sets appropriate headers, and sends it via an HTTP response or a push mechanism. The output of this step is a network message reaching the terminal, containing the natural language recommendation and associated data.

### Step 15:

The terminal receives the response and updates the display. The input of this step is the serialized response message from the server. The terminal deserializes the message to reconstruct the response structure and extracts the primary recommendation text and any associated item or product information. The terminal then renders the information in a chat-style view or list view, presenting the recommended outfit and optional purchase candidates.

The output of this step is a graphical user interface state in which the user can read the recommendations and interact with them.

### Step 16:

The user reviews the displayed recommendations and optionally provides feedback or revised constraints. The input of this step is the display content on the terminal. The user may indicate dissatisfaction with part of the recommendation, request an alternative combination, or adjust constraints such as “no jeans” or “more formal.” The user enters such information via text input or control selections. The output of this step is new input information that reflects user feedback and updated preferences.

### Step 17:

The terminal sends the feedback and updated information to the server. The input of this step is the user's new text or control selections, together with identifiers linking the feedback to a specific recommendation instance. The terminal packages this data into a structured message and transmits it to the server via the same communication mechanism used in earlier steps. The output of this step is an updated interaction record delivered to the server.

### Step 18:

The server updates behavioral and preference data and adjusts configuration for subsequent prompt sentences. The input of this step is the feedback data, including which recommended items were accepted, modified, or rejected, as well as any new wardrobe entries or preference statements. The server writes new records into behavior history tables, updates preference parameters using statistical or machine learning methods, and modifies selection conditions used for product filtering. The server may also adjust internal templates for prompt construction, such as adding stronger constraints to avoid disfavored item types. The output of this step is an updated set of user-specific parameters and configuration rules that will influence the generation of future prompt sentences and improve the performance of the system over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional clothing recommendation systems and online shopping platforms typically rely on static rule sets or simple filtering based on season, category, and user-selected preferences. Such systems often operate independently of real-time environmental context, such as current weather conditions at the user's location, and do not exploit advanced generative artificial intelligence models capable of synthesizing natural-language guidance. As a result, conventional systems frequently generate recommendations that are either too generic or only loosely aligned with the user's actual context and needs.

Furthermore, traditional architectures generally treat weather retrieval, user preference modeling, inventory access, and recommendation generation as loosely connected subsystems, requiring multiple separate service calls and ad hoc orchestration logic on the client side. This fragmented architecture increases network overhead, adds latency, and complicates client implementation. In particular, a user terminal is often required to coordinate weather acquisition, user context aggregation, and recommendation display, leading to duplicated logic across devices and making it difficult to maintain a consistent user experience across channels, including physical store environments.

In addition, conventional systems using machine learning for recommendation typically focus on ranking pre-existing items and do not employ prompt-based generative artificial intelligence models that can dynamically compose natural-language recommendations tailored to nuanced combinations of factors, such as real-time weather data, user-owned clothing information, user emotional state, and in-store inventory. Existing systems also lack a unified mechanism to dynamically modify the input to a generative artificial intelligence model—namely, the prompt sentence—based on changes in contextual signals, including updated weather data and emotion analysis results, resulting in static or stale outputs that fail to adapt over the lifecycle of a user interaction.

Another problem is that known systems rarely integrate physical store context in a technically efficient manner. Although some approaches provide QR codes or similar identifiers in stores, these codes are typically used for simple URL redirection or static content retrieval, not for driving a server-side pipeline that fuses store identification information, store inventory data, and generative artificial intelligence outputs into updated, store-specific clothing recommendations. This prevents consistent cross-channel personalization and often requires duplicative configuration for online and in-store experiences.

Moreover, existing architectures do not optimize the flow of data between a server and a generative artificial intelligence model for this domain. They do not define a structured composite context that systematically aggregates dialog information, real-time weather data, user wardrobe information, preference information, and emotion analysis results into a single prompt sentence or composite input. As a consequence, model inputs are often incomplete or noisy, reducing the quality and relevance of generated recommendations and limiting the ability to personalize at scale.

Therefore, there is a need for a technical framework that improves computer functionality by centralizing, on a server, the acquisition and integration of multi-modal, real-time contextual data; the construction and dynamic modification of prompt sentences for a generative artificial intelligence model; and the generation and post-processing of clothing recommendation information. Such a framework should reduce computational burden on user terminals, reduce network traffic through consolidated server-side processing, improve latency by optimizing calls to external information providing apparatuses, and yield more accurate and contextually relevant recommendations by feeding a rich, composite context into the generative artificial intelligence model. In addition, there is a need for a system that can seamlessly incorporate store identification information and store inventory data so that the same generative pipeline can produce online and in-store recommendations with minimal additional client logic, thereby improving the overall efficiency, maintainability, and scalability of the computer system as a whole.

The specific processing by the specific processing unit 290 of the data processing device 12 in Application Example 1 is realized by the following means.

The present invention provides a server comprising a processor and a memory storing instructions which, when executed by the processor, cause the server to acquire current location information of a user from a user terminal and, using a predetermined communication protocol, acquire weather data corresponding to the current location information from an external weather information providing apparatus; acquire, from an information storage apparatus, clothing information owned by the user and preference information of the user; generate, based on the weather data, the clothing information, and the preference information, a prompt sentence to be input to a generative artificial intelligence model; input the prompt sentence to the generative artificial intelligence model and receive clothing recommendation information generated by the generative artificial intelligence model; determine, based on a clothing type and an attribute included in the clothing recommendation information, candidate product information by filtering product information acquired from an external product providing apparatus; receive store identification information that is obtained by a user terminal reading a code installed in a physical store; acquire inventory information of the physical store from an inventory information source; associate the inventory information with the clothing recommendation information to generate store-specific clothing recommendation information; acquire input information and emotion information of the user via an input interface and a sensor device; perform emotion analysis processing to obtain an emotion analysis result; dynamically modify the prompt sentence according to the emotion analysis result and the weather data; re-input the modified prompt sentence to the generative artificial intelligence model to generate updated clothing recommendation information; and transmit at least one of the clothing recommendation information, the updated clothing recommendation information, the candidate product information, and the store-specific clothing recommendation information to the user terminal for display. This enables centralized server-side integration of real-time weather data, user wardrobe data, user preference data, user dialog and emotion data, and store inventory data into dynamically generated prompt sentences for a generative artificial intelligence model, thereby improving computer system performance by reducing client-side processing, optimizing external service calls, and generating more accurate, context-aware, and location-specific clothing recommendations in both online and in-store environments.

The term “processor” refers to a hardware computing element or a combination of hardware computing elements that executes machine-readable instructions, including a central processing unit, a graphics processing unit, a digital signal processor, or any integrated circuit capable of performing arithmetic and logical operations.

The term “memory” refers to a hardware storage medium or a combination of hardware storage media that stores machine-readable instructions and data, including volatile memory, non-volatile memory, or any computer-readable storage medium accessible by the processor.

The term “user terminal” refers to an information processing apparatus operated by a user, including but not limited to a smartphone, a tablet, a portable computer, a fixed computer, or any network-capable electronic device having an input interface, a display device, and a communication interface.

The term “current location information” refers to information indicating a physical position associated with a user or a user terminal, including but not limited to geographic coordinates, address data, or any data that can be used to identify a position on or relative to the surface of the Earth.

The term “predetermined communication protocol” refers to a defined set of rules and formats for exchanging data between devices or systems, including but not limited to protocols based on a transport control protocol, an internet protocol, a hypertext transfer protocol, or an application programming interface protocol.

The term “weather data” refers to information indicating environmental conditions at a given place and time, including but not limited to temperature, precipitation, humidity, wind, cloud coverage, weather condition codes, and descriptive text relating to atmospheric phenomena.

The term “external weather information providing apparatus” refers to a remote computing system or service that provides weather data via a communication network in response to a request including at least location information or a location identifier.

The term “information storage apparatus” refers to any hardware system or subsystem configured to store and provide data, including a database server, a storage area network, a file server, or any other persistent or semi-persistent storage system.

The term “clothing information” refers to data describing one or more clothing items associated with a user, including but not limited to item categories, sizes, colors, materials, styles, seasonal attributes, usage attributes, or any other metadata indicative of characteristics of the clothing items.

The term “preference information” refers to data indicating tendencies, likes, dislikes, or constraints of a user, including but not limited to style preferences, color preferences, budget ranges, brand tendencies, formality levels, or occasions for which clothing is preferred.

The term “prompt sentence” refers to text data or a sequence of tokens that is formatted as an instruction, request, or context description, and that is configured to be input to a generative artificial intelligence model to control the content, style, or structure of an output generated by the model.

The term “generative artificial intelligence model” refers to a machine-learned model that is configured to generate new data, such as natural-language text, in response to an input, including but not limited to a neural network-based model trained on large-scale data for language generation or multimodal generation.

The term “clothing recommendation information” refers to information generated based on processing by the generative artificial intelligence model or the processor, indicating at least one clothing combination, outfit proposal, or guidance for clothing selection, and optionally including explanations or reasons for the proposal.

The term “clothing type” refers to a classification label associated with a clothing item, including but not limited to categories such as tops, bottoms, outerwear, footwear, accessories, or any other functional or stylistic category.

The term “attribute” refers to a property associated with a clothing item or product, including but not limited to material, color, size, pattern, water resistance, thermal insulation level, formality level, or target use case.

The term “external product providing apparatus” refers to a remote computing system or service that manages and provides product information, including but not limited to an online commerce server, a merchandise catalog system, or a product database accessible via a communication network.

The term “product information” refers to data describing a product, including but not limited to a product identifier, category, attributes, price, availability, image data, descriptive text, and links to additional details or purchase options.

The term “candidate product information” refers to a subset of product information selected or filtered based on at least clothing recommendation information, clothing types, attributes, user preferences, or contextual conditions for presentation to a user as candidate items.

The term “code installed in a physical store” refers to a machine-readable symbol or identifier displayed or embedded within a store facility, including but not limited to a two-dimensional code, a one-dimensional code, a radio-frequency identification tag, or any optically or wirelessly readable marker.

The term “store identification information” refers to information indicating an identity of a store or a store-related entity, including but not limited to a store identifier, a location code, a section identifier, or a campaign identifier derived from a code installed in a physical store.

The term “inventory information” refers to data indicating availability, quantity, or location of products within a store or across multiple stores, including but not limited to stock-keeping unit identifiers, stock levels, storage positions, and reservation status.

The term “store-specific clothing recommendation information” refers to clothing recommendation information that has been adjusted or generated based on inventory information of at least one store and is thus configured to propose items that are available in that store.

The term “input interface” refers to a hardware and software mechanism that enables acquisition of input information from a user or another device, including but not limited to a graphical user interface, a touch input device, a keyboard, a pointing device, a microphone, or a network input interface.

The term “sensor device” refers to hardware capable of detecting or measuring physical quantities or signals and providing corresponding data, including but not limited to a camera, a microphone, a location sensor, a motion sensor, or a biometric sensor.

The term “input information” refers to data explicitly provided by a user or another system, including but not limited to text input, selection input, voice input, gesture input, and structured or unstructured data transmitted via a communication interface.

The term “emotion information” refers to raw or pre-processed data indicative of a user's emotional state, acquired from at least one sensor device, including but not limited to facial expression data, voice data, textual expressions, or physiological measurements.

The term “emotion analysis processing” refers to computational processing that analyzes emotion information to derive an emotion analysis result, including but not limited to classification of emotional categories, estimation of emotional intensity, or detection of affective trends.

The term “emotion analysis result” refers to output data produced by emotion analysis processing, indicating at least one inferred emotional state or parameter associated with a user, which can be used to modify or adapt subsequent processing.

The term “updated clothing recommendation information” refers to clothing recommendation information that has been newly generated or altered based on a modified prompt sentence or modified context, including changes reflecting updated emotion analysis results, updated weather data, or updated user inputs.

The term “dialog information” refers to information representing an exchange of messages between a user and a system, including but not limited to chat-style text input, prior system responses, and any conversational metadata relevant to the context of interaction.

The term “composite context” refers to a structured aggregation of multiple categories of information, including at least dialog information, weather data, clothing information, preference information, and an emotion analysis result, which is provided collectively as input to the generative artificial intelligence model.

The term “real time” refers to processing that occurs within a time frame that permits a user to receive updated results without perceiving undue delay, including processing that reacts to changes in context, such as weather or emotion, within a short and practically immediate period.

The term “display” refers to the act of presenting information on a visual output device of a user terminal, including but not limited to rendering text, images, icons, or interactive elements on a screen.

In one or more embodiments, a server, at least one terminal, and at least one user cooperate to implement a context-aware clothing recommendation system that utilizes a generative AI model based on prompt sentences. The following description illustrates exemplary embodiments that support the scope of the claims. The embodiments are not limited to any particular hardware vendor or product and may be implemented using functionally equivalent components.

In an exemplary embodiment, the server comprises one or more processors and one or more memories. The server executes an operating system such as a general-purpose server operating system and runs server-side application software implemented, for example, using a web application framework (for instance, a framework similar to a Python-based framework, a Java-based framework, or a JavaScript-based framework). The server further communicates with an external weather information providing apparatus, an external product providing apparatus, and a model execution environment for a generative AI model via a communication network based on a transport control protocol and an internet protocol, and uses protocols such as hypertext transfer protocol or secure hypertext transfer protocol on top of the transport layer.

In an exemplary embodiment, the terminal comprises a processor, a memory, a display device, a communication interface, at least one input interface such as a touch panel or a keyboard, and at least one sensor device such as a global positioning system (GPS) module, a camera, or a microphone. The terminal executes a mobile operating system (for example, an operating system for smartphones or tablets) and runs an application program that interacts with the server via a network library using an application programming interface.

In an exemplary embodiment, the user operates the terminal to launch the application program.

The terminal displays a graphical user interface that enables the user to input natural-language questions such as “What should I wear today?” or “Recommend an outfit for a rainy day commute.” The terminal acquires the user's current location information by calling a location service module of the operating system, which in turn controls GPS hardware and, optionally, wireless network-based positioning functions.

In an exemplary embodiment, the server acquires the current location information of the user from the terminal and queries the external weather information providing apparatus via a defined web application programming interface. The external weather information providing apparatus returns weather data comprising temperature, precipitation status, weather condition codes, humidity, and other environmental parameters. The server parses the returned structured weather data, for example, in JavaScript Object Notation format, and stores the parsed data in a relational database management system such as a database server compatible with Structured Query Language.

In an exemplary embodiment, the server accesses an information storage apparatus that stores clothing information and preference information associated with the user. The server retrieves records from one or more database tables that represent user-owned clothing items and user preference profiles. The clothing information is represented as structured records including fields such as an item identifier, a clothing type (e.g., top, bottom, outerwear, footwear), a material type (e.g., cotton, synthetic, leather), a warmth index, a water resistance flag, a color code, and one or more style tags. The preference information is represented as structured records that include a preferred style category (e.g., casual, business, formal), disfavored colors, price range preferences, and, in some embodiments, past acceptance or rejection labels for previous recommendations.

In an exemplary embodiment, the server generates a prompt sentence to be input to a generative AI model. The server constructs the prompt sentence by applying a deterministic template-filling procedure to the weather data, clothing information, preference information, and, in some embodiments, dialogue history and emotion analysis results. The server uses a prompt template such as:

“The user asks: ‘What should I wear today?’. Current weather: rain, 10° C. The user owns: black waterproof jacket, gray knit sweater, blue jeans, white sneakers. The user prefers casual style.

Recommend a complete outfit for going outside today and explain briefly.”

In another example, the server uses a prompt template such as:

“Current weather: sunny, 25° C. The user owns: white cotton T-shirt, navy chinos, light denim jacket, white sneakers. The user prefers smart casual style. Recommend a comfortable and stylish outfit using mainly the owned clothes, and suggest one additional item that the user could purchase online.”

The server stores such prompt templates and replaces placeholder tokens with specific values extracted from the database and the weather response. The server also appends conversation history, for example, prior user questions and prior system responses, to the prompt sentence separated by special delimiters, such that the generative AI model receives a coherent dialogue context.

In an exemplary embodiment, the generative AI model is implemented as a multi-layer neural network, such as a transformer-based language model. The server accesses the generative AI model via an application programming interface exposed by a model execution environment running on dedicated hardware, such as a cluster of graphics processing units or tensor processing units. The generative AI model comprises an embedding layer that maps tokens of the prompt sentence to continuous vector representations, a plurality of self-attention layers with multiple attention heads, and feedforward layers. The model has been trained, prior to deployment, on a large corpus of text data using a language modeling objective that minimizes a cross-entropy loss between predicted token distributions and ground-truth tokens. During training, the model updates weight parameters via stochastic gradient descent or a variant thereof (for example, an adaptive moment estimation algorithm), using backpropagation. The training process may incorporate regularization such as dropout and layer normalization to improve generalization and stability.

In an exemplary embodiment, the server sets control parameters for the generative AI model, such as a temperature parameter for sampling diversity, a maximum output length, and a top-k or top-p sampling threshold, to ensure that the generated clothing recommendation information remains concise and domain-appropriate. The server transmits the prompt sentence and the control parameters to the generative AI model. The model performs forward propagation of the prompt sentence tokens through the network, computes attention scores and aggregated context vectors across layers, and outputs a sequence of tokens representing the generated text. The server receives this generated text as clothing recommendation information.

In an exemplary embodiment, the server post-processes the clothing recommendation information using a combination of string parsing and rule-based extraction. The server identifies explicit mentions of clothing items by matching tokens or phrases against entries in the clothing information database and against a controlled vocabulary of clothing types and attributes. For example, if the generated text contains the sentence “Wear the gray knit sweater with the blue jeans and the black waterproof jacket, along with your white sneakers,” the server extracts the tokens “gray knit sweater,” “blue jeans,” “black waterproof jacket,” and “white sneakers” and maps them to internal item identifiers stored for the user.

In an exemplary embodiment, the server queries the external product providing apparatus for candidate products that match the clothing types and attributes derived from the clothing recommendation information. The external product providing apparatus exposes an application programming interface that accepts query parameters such as category, size, color, material, and price range. The server constructs queries using the extracted clothing types, attributes, and preference information, and obtains product information including product identifiers, prices, stock status, and product images. The server filters the returned product information based on additional rules, such as excluding items that conflict with user preferences and ranking items by a scoring function that balances relevance, predicted fit to weather conditions, and estimated satisfaction. The server stores the resulting candidate product information in a structured format associated with the user and a recommendation session identifier.

In an exemplary embodiment, the server also integrates physical store context into the generation of recommendations. The user operates the terminal to scan a machine-readable code installed in a physical store using a camera and a code decoding library. The terminal decodes store identification information from the code and transmits the store identification information to the server along with a user identifier. The server uses the store identification information to retrieve inventory information from a store-side inventory management system or an aggregated product information service. The inventory information includes stock-keeping unit identifiers, quantities, and locations within the store. The server associates the clothing recommendation information with the inventory information to produce store-specific clothing recommendation information, for example, by replacing generic clothing references with specific items that are available in the store, and by appending location guidance such as “navy waterproof trench coat (available on rack A3).”

In an exemplary embodiment, the terminal receives the clothing recommendation information, updated clothing recommendation information, candidate product information, and store-specific clothing recommendation information as structured data from the server. The terminal renders these data on the display device as a series of user interface panels, which may include textual explanations, item names, thumbnail images, and interactive controls for viewing details or initiating purchases. The terminal uses graphical layout components provided by the mobile operating system to present the information in a consistent and visually clear manner. The user can tap an item to view item details, or can provide feedback such as “like” or “dislike,” which the terminal transmits back to the server for use in updating preference information.

In an exemplary embodiment, the server acquires emotion information by receiving facial image data from the terminal's camera, voice data from the terminal's microphone, or textual sentiment indicators. The server applies an emotion analysis processing pipeline that may include a convolutional neural network for facial expression analysis, a recurrent or transformer-based neural network for speech prosody analysis, or a sentiment analysis model for text. The server computes an emotion analysis result, such as a probability distribution over emotional categories (e.g., happy, neutral, stressed) and an intensity score. The server then updates the prompt sentence to include terms such as “The user seems stressed and prefers comfortable clothing today,” or modifies the style constraints accordingly. For example, the server may generate a prompt sentence such as:

“Current weather: cloudy, 15° C. The user appears slightly stressed and prefers comfortable casual clothes. The user owns: black hoodie, gray sweatpants, white sneakers. Recommend a comfortable outfit suitable for a relaxed evening walk and explain briefly.”

In this manner, the server dynamically modifies the prompt sentence based on the emotion analysis result and other contextual data so that the generative AI model can generate updated clothing recommendation information that accounts for emotional state as well as environmental conditions.

In an exemplary embodiment, the server constructs a composite context data structure that aggregates weather data, clothing information, preference information, dialog information, and emotion analysis results in a normalized representation. The server serializes this composite context into a prompt sentence or into multiple segments of a prompt for the generative AI model. By standardizing the composite context, the server reduces redundancy and ensures that only relevant features are transmitted to the model, which shortens the prompt and reduces the number of tokens processed per request. As a result, the server improves processing speed and reduces computational and communication overhead compared to naive approaches that transmit entire history logs and unfiltered metadata to the model.

In some embodiments, the server applies an internal feature engineering step before generating the prompt sentence. The server computes derived features such as a weather comfort index, a rain risk level, or a formality score for upcoming events based on multiple raw inputs. The server includes these derived features in the prompt sentence as summarized natural-language phrases such as “It is cold and rainy, with a high risk of getting wet during the commute,” which helps the generative AI model focus on semantically important factors. By performing such pre-processing on the server, the system reduces the need for the generative AI model to infer all context details from raw data, thereby improving the accuracy and stability of the generated clothing recommendation information.

In an exemplary embodiment, the server architecture is modularized into distinct components, including a location and weather acquisition module, a user profile and wardrobe management module, a prompt generation module, a generative model interaction module, a recommendation post-processing and product matching module, a store inventory integration module, and an emotion analysis module. Each module communicates via defined data interfaces and uses explicit data structures. For example, the prompt generation module receives a context object containing normalized weather records, wardrobe lists, preference attributes, and emotion tags, and outputs a prompt sentence as a string. The generative model interaction module receives the prompt sentence and outputs generated text. The recommendation post-processing module receives generated text and outputs a structured recommendation object.

This modular structure permits independent scaling, monitoring, and optimization of each processing stage, which is a technical improvement over monolithic, tightly coupled implementations.

In some embodiments, the system improves data management by storing context snapshots and recommendation outputs with version identifiers. The server assigns a unique context identifier each time the composite context changes significantly, and associates each recommendation with the context identifier and timestamp. The server thus enables later re-evaluation or comparison of recommendations based on different prompt formulations, facilitating offline analysis and incremental improvement of prompt templates. This leads to more efficient prompt design and reduces trial-and-error cycles that would otherwise require human operators to repeatedly test and adjust rules.

In some embodiments, the server reduces communication load by aggregating several user interactions into a single call to the generative AI model when appropriate. For instance, when the user asks multiple related questions in a short period, the server combines the questions and the recent answers into a single extended prompt, rather than issuing multiple independent requests. The server thus decreases the number of network transmissions and model invocations, leading to reduced latency and better resource utilization on the model execution environment.

In some embodiments, the system improves processing speed and recommendation quality compared to human-driven methods or static rule-based systems by leveraging the high-dimensional representation capabilities of the generative AI model. While a human stylist or a simple recommendation engine might manually match clothing categories to weather, the server uses the generative AI model to synthesize nuanced natural-language justifications, discover non-obvious clothing combinations, and account for multi-factor dependencies such as hairstyle compatibility, typical commuter duration, or indoor/outdoor temperature differences, as encoded in the training data. At the same time, the server constrains and structures the problem through prompt engineering and post-processing so that the generative AI model operates within a technically controlled framework.

In some embodiments, alternatives are provided. The terminal may be a wearable device such as a smartwatch or smart glasses, in which case the terminal acquires biometric signals such as heart rate, and the server includes these signals in the composite context to refine emotion analysis or comfort-level estimation. The generative AI model may run locally on an edge device for privacy-sensitive deployments, in which case the server transmits a compact representation of the composite context rather than raw data. The emotion analysis module may be omitted in environments where sensor data is restricted; in such cases, the server relies on self-reported mood or skips emotion-based modifications to the prompt sentence.

In other embodiments, the generative AI model may be specialized for multilingual output. The server includes an explicit language instruction in the prompt sentence, such as “Respond in Japanese” or “Respond in English,” allowing the same model to serve diverse user populations without duplicating rule-based logic. The server thus reduces the number of separate language-specific modules that must be implemented and maintained, which improves maintainability and scalability of the computer system.

By centralizing prompt sentence generation, composite context construction, and generative AI model interaction on the server, while utilizing terminal-side sensors and interfaces only for input acquisition and display, the system achieves a technical improvement in overall computer operation. The system reduces terminal-side complexity, standardizes data structures, and optimizes the flow and processing of high-dimensional contextual information, leading to faster, more accurate, and more contextually adaptive clothing recommendations than could be achieved by conventional rule-based recommendation engines or by human operators relying on manual procedures.

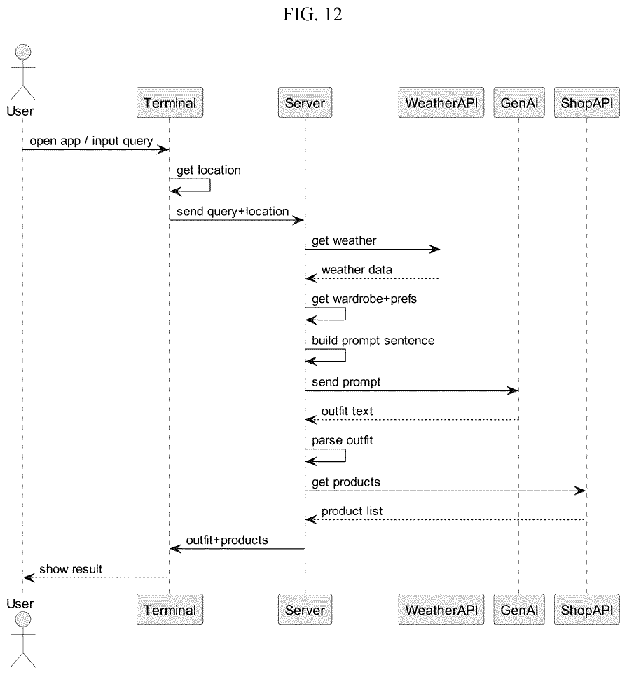

The following describes the processing flow using FIG. 12.

### Step 1:

User launches the application on the terminal and initiates a clothing consultation.

User taps an icon on the terminal to start the clothing recommendation application and selects a function such as “Today's outfit” or opens a chat input box.

Input: No structured data; a user action on the terminal UI.

Output: A request state in the terminal indicating that a new recommendation session should be started.

### Step 2:

Terminal acquires user text input and prepares a base request object.

Terminal displays a text input field and a send button, and User enters a natural-language query such as “What should I wear today?” or “Recommend an outfit for a rainy commute.”

Terminal stores the entered text in memory and creates an internal request object containing at least a user identifier and the text input.

Input: User text input and user identifier stored on the terminal.

Output: A base request object containing the user identifier and the user's query string.

### Step 3:

Terminal acquires current location information.

Terminal calls an operating system location service to retrieve current latitude and longitude, activating GPS hardware or network-based positioning as necessary.

Terminal waits until a valid location fix is obtained and then adds the coordinates to the base request object.

Input: Base request object without location and raw sensor signals from GPS and network modules.

Output: An enriched request object including user identifier, user query, and precise location coordinates.

### Step 4:

Terminal transmits the enriched request object to the server.

Terminal serializes the request object into a structured message and sends it via a secure communication protocol to a predefined server endpoint designated for clothing recommendation requests.

Input: Enriched request object in terminal memory.

Output: A network message delivered to the server containing user identifier, user query, and location information.

### Step 5:

Server receives, validates, and logs the request.

Server accepts the incoming network message at an application interface, deserializes the payload, and extracts the user identifier, query text, and location data.

Server validates that all required fields are present and that the location values are within acceptable ranges, and writes a log entry containing these values for monitoring and traceability.

Input: Network message containing user identifier, user query, and location coordinates.

Output: A validated and logged internal request record ready for further processing.

### Step 6:

Server acquires weather data based on the location.

Server constructs a weather query using the location coordinates and sends a request to an external weather information providing apparatus over the network.

Server receives weather data, parses the structured response, and extracts parameters such as temperature, precipitation condition, humidity, and textual descriptions.

Input: Validated internal request record containing location coordinates.

Output: A weather context object containing normalized weather parameters associated with the user and the current time.

### Step 7:

Server retrieves clothing information and preference information from storage.

Server queries an information storage apparatus, such as a database, using the user identifier to obtain a list of clothing items owned by the user and a set of preference records.

Server filters and normalizes these records into structured lists and attributes, such as clothing categories, materials, warmth levels, and preferred styles.

Input: User identifier from the internal request record.

Output: A user profile context containing a wardrobe list and preference attributes.

### Step 8:

Server constructs a composite context object.

Server combines the weather context object, the user profile context, and the original user query into a single composite context structure.

Server computes derived features such as comfort level or rain risk from the raw weather parameters and attaches them to the composite context to simplify later processing.

Input: Weather context object, user profile context, and user query.

Output: A composite context object that aggregates all relevant information for prompt generation.

### Step 9:

Server optionally acquires dialog information and emotion analysis results.

Server checks whether the user has prior conversation history or emotion data in the current session.

If such data exists, Server retrieves past user queries and system responses, and retrieves or computes an emotion analysis result based on stored sensor-derived signals or sentiment analysis of past text.

Input: User identifier and composite context object.

Output: An expanded composite context object that includes dialog history and an emotion analysis result, if available.

### Step 10:

Server generates a prompt sentence for the generative AI model.

Server selects a template suitable for clothing recommendation and fills placeholders with values from the composite context, such as weather summary, owned clothing items, style preferences, and, optionally, emotion indications.

Server produces a natural-language prompt sentence such as:

“The user asks: ‘What should I wear today?’. Current weather: rain, 10° C. The user owns: black waterproof jacket, gray knit sweater, blue jeans, white sneakers. The user prefers casual style.

Recommend a complete outfit for going outside today and explain briefly.”

Input: Expanded composite context object containing weather, wardrobe, preferences, and optional emotion and dialog information.

Output: A fully formed prompt sentence string configured for input to the generative AI model.

### Step 11:

Server sets generative AI model control parameters and sends the prompt.

Server prepares a model request including the prompt sentence and parameters such as temperature, maximum token length, and sampling strategy.

Server transmits this model request to a generative AI model execution environment using a model-specific application programming interface.

Input: Prompt sentence and internal configuration values for model behavior.

Output: A generative AI model request sent to the model environment, initiating text generation.

### Step 12:

Server receives generated clothing recommendation information from the generative AI model.

Server waits for the model execution environment to process the prompt, then receives generated text output representing a clothing recommendation.

Server validates that the output is non-empty, well-formed, and within length constraints, rejecting or regenerating if necessary.

Input: Generative AI model response containing a sequence of tokens representing generated text.

Output: Raw generated clothing recommendation text ready for post-processing.

### Step 13:

Server parses and structures the generated clothing recommendation information.

Server scans the generated text to identify mentions of specific clothing items and attributes by matching against known clothing types and user-owned items.

Server constructs a structured recommendation object that separates fields such as top, bottom, outerwear, footwear, and explanation text, based on parsed content.

Input: Raw generated clothing recommendation text and stored vocabulary or wardrobe metadata.

Output: A structured clothing recommendation object that specifies item roles and justification text.

### Step 14:

Server acquires candidate product information from an external product providing apparatus.

Server extracts clothing types and attributes from the structured recommendation object and formulates queries to the external product providing apparatus.

Server receives lists of products, filters them according to user preference information and technical constraints (such as size and availability), and ranks remaining products using a scoring algorithm.

Input: Structured clothing recommendation object and user preference attributes.

Output: A curated candidate product list aligned with the recommended outfit and user preferences.

### Step 15:

Server integrates store identification information and inventory information, if available.

Server checks whether the internal request record or a later message from the terminal includes store identification information obtained by terminal code scanning.

If store identification information exists, Server queries a store inventory system, retrieves inventory data for relevant product categories, and filters the candidate product list and user-owned items to those available in the store.

Input: Structured clothing recommendation object, candidate product list, and store identification information.

Output: Store-specific clothing recommendation information that references actual in-store items and their locations.

### Step 16:

Server optionally modifies the prompt sentence and regenerates updated clothing recommendation information.

Server determines whether new emotion analysis results, updated weather data, or additional user inputs warrant regeneration.

If regeneration is needed, Server modifies the prompt sentence to reflect the changes, sends the updated prompt to the generative AI model, receives new text output, and repeats the parsing and structuring described previously to create updated clothing recommendation information.

Input: Original prompt sentence, composite context object, and updated context signals such as emotion analysis results.

Output: An updated structured clothing recommendation object that refines or replaces the original recommendation.

### Step 17:

Server composes a final response payload for the terminal.

Server merges the latest clothing recommendation object, any updated recommendation object, the candidate product list, and any store-specific clothing recommendation information into a unified response structure.

Server includes identifiers, timestamps, and flags indicating which part of the recommendation is global and which part is store-specific.

Input: Structured recommendation object(s), candidate product list, and store-specific recommendation object, if present.

Output: A final response payload ready for transmission to the terminal.

### Step 18:

Server transmits the final response payload to the terminal.

Server serializes the unified response structure into a message format suitable for network transmission and sends it to the terminal over the secure communication channel.

Input: Final response payload in server memory.

Output: A network message delivered to the terminal containing all recommendation and product information.

### Step 19:

Terminal receives, parses, and stores the recommendation data.

Terminal accepts the incoming message, deserializes the payload, and extracts the structured clothing recommendation, candidate products, and any store-specific information.

Terminal stores relevant identifiers and context data locally for possible later reuse, such as display refresh or follow-up user interactions.

Input: Network message from the server containing structured recommendation data.

Output: Parsed recommendation data and local state entries on the terminal.

### Step 20:

Terminal displays the clothing recommendation information to the user.

Terminal renders a user interface that shows the recommended outfit components, explanatory text, and associated candidate products, using layout and rendering functions of the terminal operating system.

Terminal highlights items available in the current store when store-specific information exists, and may display rack numbers or sections for in-store navigation.

Input: Parsed recommendation data stored in terminal memory.

Output: Visual presentation of recommendations on the terminal display for user consumption.

### Step 21:

User interacts with the displayed recommendations and optionally provides feedback.

User views the recommended outfit, taps on items to view details, follows links to purchase pages, or indicates preferences such as “like,” “dislike,” or “show more similar items.”

Terminal captures these actions as feedback events and prepares them for transmission to the server in subsequent interactions.

Input: Visual information displayed on the terminal and user interactions with the user interface.

Output: Feedback events and follow-up requests that can be used by the server to refine future composite contexts and prompt sentences.

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional coordination support systems that propose outfits to a user typically rely on static rule sets, simple similarity matching, or generic recommendations that are not tightly coupled to the actual inventory of clothing items possessed by the user. In many implementations, natural language questions from the user (for example, “What should I wear with my red skirt today?”) are either handled by rudimentary keyword matching or are passed directly to a generative AI model without a structured representation of the user's wardrobe or preferences. As a result, such systems frequently generate proposals that include items the user does not own, omit items that are highly relevant, or produce responses that are inconsistent or difficult to map back to concrete items stored in a database.

From a computer-technology standpoint, existing approaches exhibit several technical deficiencies. First, databases storing user clothing data are often queried in a simplistic way, without dynamic conditioning on the semantics of the user's natural language question. This leads to inefficient data retrieval and underutilization of the structured attributes (such as category, color, use, season, or scene) that are already available in the data store. Second, the interface between the application logic and a generative AI model is usually an unstructured prompt that does not systematically constrain the model to operate over a well-defined subset of items associated with the user. This lack of tight integration results in unnecessary token usage, inconsistent behavior, and difficulty in reliably mapping text outputs back to internal item identifiers in the storage system.

Third, many systems do not provide a feedback-aware pipeline in which user evaluation information and preference information are captured at the system level and then fed back into the processes for generating prompts and searching stored item information. Consequently, such systems fail to improve retrieval accuracy and generation quality over time at the level of the underlying computing infrastructure. Fourth, systems that attempt to combine the user's owned clothing with external product information, such as items obtained from online information sources, typically treat external product data as a separate recommendation channel. This separation limits the ability of the computing system to generate integrated proposals that seamlessly blend owned items and candidate products under unified constraints expressed within a prompt to a generative AI model.

Therefore, there is a need for an improved computer-implemented system that: (i) structurally links natural language questions to attribute-aware retrieval of user-specific item information from a storage region; (ii) programmatically generates constrained and structured prompt sentences for a generative AI model based on such retrieved information; (iii) performs systematic post-processing that maps generated text outputs back to internal item identifiers and augments the outputs with associated image information and attribute information; and (iv) iteratively updates retrieval and prompt generation behavior based on user evaluation information and preference information. Such a system should enhance the technical operation of the server and database, reduce unnecessary computation and data transfer, and provide a more deterministic and controllable interaction with the generative AI model while still leveraging its expressive generation capabilities.

The specific processing by the specific processing unit 290 of the data processing device 12 in Example 2 is realized by the following means.

The present invention provides a server comprising a processor and a storage device, the processor being configured to (i) receive item information representing clothing possessed by a user from a terminal and store the item information in a storage region of the storage device on a per-user basis in a structured form using higher-level attribute classifications; (ii) obtain, from the terminal, a natural language question input by the user, analyze the question to extract attributes including at least color, category, use, season, and scene, and search the storage region for clothing item information related to the extracted attributes; (iii) convert the searched clothing item information into summarized text-form representations and programmatically generate a prompt sentence for a generative natural language processing model by combining the summarized representations with contents of the question and system-level constraint conditions; (iv) transmit the prompt sentence to an internal or external generative natural language processing model, obtain text data representing outfit proposals generated by the model within a range constrained to the clothing item information possessed by the user, and analyze the text data to detect references to specific clothing items; (v) map the detected references to clothing identification information stored in the storage region, construct structured data in which each outfit proposal is associated with one or more clothing identification information entries, and augment the structured data with corresponding image information and attribute information retrieved from the storage region; (vi) generate presentation data including the structured data as text information and image information and transmit the presentation data to the terminal for visual or textual presentation; and (vii) acquire evaluation information or preference information from the user via the terminal, store the evaluation information or the preference information in the storage region, and update at least one of the searching of the clothing item information and the generation of the prompt sentence based on the stored evaluation information or preference information so as to iteratively improve subsequent outfit proposals. This enables a technically improved coordination support pipeline in which database retrieval, prompt construction, and generative model interaction are tightly integrated at the system level, thereby reducing inconsistent or irrelevant outputs, constraining generation to user-specific data, improving the efficiency and determinism of server-side processing, and providing a feedback-adaptive mechanism that enhances the quality and relevance of outfit proposals over time.

The term “processor” refers to a hardware or virtual computing resource, such as a central processing unit, a graphics processing unit, or a combination of such resources, that executes instructions of one or more programs to perform data processing operations described in this specification.

The term “storage device” refers to a hardware component or a combination of hardware components, such as a magnetic storage medium, a semiconductor memory, or a solid-state storage apparatus, that is configured to store data persistently or semi-persistently under the control of the processor.

The term “storage region” refers to a logical area within the storage device, such as a database table, a data structure, or a file space, that is allocated for storing and managing item information, evaluation information, or other data associated with one or more users.

The term “terminal” refers to an information processing apparatus, such as a portable communication device, a stationary computing device, or an interactive display device, that is configured to communicate with the server, provide a user interface, and transmit or receive data including item information, questions, and presentation data.

The term “user” refers to an individual or entity that interacts with the terminal and the server to register clothing items, input natural language questions, and receive or evaluate outfit proposals generated by the system.

The term “item information” refers to data representing attributes of a clothing item or a related article, including but not limited to category, color, size, material, usage, season, scene, and associated image information, that is stored in the storage region on a per-item basis.

The term “clothing item information” refers to item information specifically associated with articles of clothing or wearable items possessed by the user, and includes attribute information and identification information for such articles.

The term “clothing identification information” refers to data that uniquely identifies a clothing item within the storage region, such as an item identifier, a record key, or a combination of fields that can be used to retrieve the corresponding clothing item information.

The term “attribute information” refers to descriptive data associated with an item, including but not limited to color, category, use, season, scene, style, or other higher-level classifications that characterize the item for retrieval, analysis, and presentation.

The term “higher-level classifications” refers to generalized or abstracted categories or groupings of attribute information, such as grouping multiple specific types of items under a broader category or mapping specific colors to broader color families, that facilitate structured storage and retrieval of item information.

The term “natural language question” refers to a text or speech input expressed in a human language by the user, containing at least one inquiry or instruction related to outfit coordination or use of clothing items, which is to be analyzed by the processor.

The term “generative natural language processing model” refers to a computational model implementing a generative artificial intelligence technique that receives a prompt sentence or similar input and outputs generated text by predicting or constructing sequences of linguistic tokens based on learned parameters.

The term “prompt sentence” refers to text data that encodes instructions, constraints, and contextual information, including at least a representation of clothing item information and a reformulated version of a user's question, and that is provided as input to the generative natural language processing model to guide generation of text outputs.

The term “outfit proposal” refers to information indicating a combination of two or more clothing items, and optionally additional items, that are recommended to be worn together under certain conditions such as use, season, or scene, the information being represented at least in text form and optionally in association with images.

The term “text data” refers to a sequence of characters or tokens representing content such as questions, prompt sentences, or generated descriptions of outfit proposals, that can be processed by the processor and the generative natural language processing model.

The term “summarized text-form representations” refers to condensed textual descriptions of clothing item information that include essential attributes such as category, color, and use, while omitting or compressing less critical details to reduce data volume while preserving relevance.

The term “presentation data” refers to data generated by the processor for output to the terminal, the data including at least text information and image information representing outfit proposals, and being formatted to enable visual or textual presentation on the terminal.

The term “image information” refers to data representing a visual depiction of a clothing item or an outfit, including but not limited to a digital image file, an image reference, or metadata associated with such a visual depiction.

The term “evaluation information” refers to data indicating a user's response to an outfit proposal or an item, such as a rating, a selection, a rejection, or other feedback, that is stored and used to adjust subsequent processing.

The term “preference information” refers to data representing tendencies or patterns in the user's choices or evaluations, including inferred or explicitly provided likes, dislikes, favored attributes, or frequently selected combinations, derived from evaluation information or usage history.

The term “usage history” refers to data representing past interactions of the user with the system, including but not limited to accessed outfit proposals, selected items, or executed queries, which can be analyzed to infer preferences or tendencies.

The term “browsing history” refers to data representing items, proposals, or content viewed by the user via the terminal over time, and that can be used to analyze interest patterns or preferences.

The term “preference history” refers to a log or accumulation of preference information over time, including historical ratings, selections, and feedback, stored in the storage region for analysis.

The term “statistical analysis” refers to computational processing that applies statistical methods, such as counting, averaging, clustering, or correlation analysis, to usage history, browsing history, or preference history to derive patterns or scores.

The term “data mining” refers to a computational technique for discovering patterns, associations, or structures in large datasets, including but not limited to machine learning methods, clustering, or association rule discovery applied to user-related data.

The term “online information source” refers to a remote information providing system accessible via a communication network, such as an online catalog or content distribution service, that supplies product information or other data related to clothing items.

The term “product information” refers to item information obtained from an online information source, including attributes and identifiers of candidate clothing items that are not yet possessed by the user but may be considered for recommendation.

The term “constraint conditions” refers to rules, limitations, or parameters applied when generating a prompt sentence or processing a generative model output, including restrictions to items possessed by the user, conditions on season or use, or output format requirements.

### A. Overall Configuration and Hardware/Software Environment

The server executes one or more computer programs on a processor such as a multi-core central processing unit and, in some embodiments, an auxiliary graphics processing unit. The server uses a storage device including at least a nonvolatile storage medium such as a solid-state drive and a volatile memory such as a dynamic random access memory. The server executes an operating system such as a general-purpose server operating system and runs middleware such as a web server and an application framework.

The server, in one embodiment, executes an application implemented in a general-purpose programming language such as Python or Java, using a web application framework such as a typical model-view-controller framework. The server manages user clothing item information, evaluation information, and preference information in a database management system such as a relational database management system (for example, a system conforming to the SQL standard) stored on the storage device. The server, in some embodiments, stores image information for clothing items in an object storage system and stores corresponding identifiers or URLs in the relational database.

The terminal is an information processing apparatus such as a smartphone, a tablet, a laptop computer, or a desktop computer. The terminal includes a processor, a memory, a display device, a user input device (such as a touch panel, a keyboard, or a pointing device), and in some embodiments an image capture device and a wireless communication interface. The terminal executes a client program, which may be implemented as a native application (for example, in a mobile operating system environment) or as a browser-based web client using a scripting language and a graphical user interface library.

The user operates the terminal to register clothing items, input natural language questions, view outfit proposals, and provide evaluation information or preference information. The terminal communicates with the server via a communication network such as the Internet, using a communication protocol such as HTTPS.

The server accesses a generative AI model via an application programming interface. The generative AI model, in one embodiment, is implemented as a large-scale neural network-based generative natural language processing model executed on remote computational resources such as graphics processing units or tensor processing accelerators in a data center. The server interacts with the generative AI model through a standardized request-response interface provided by a model serving platform. In another embodiment, the server executes the generative AI model locally on one or more accelerators, with similar interfaces.

### B. Data Structures in the Server

The server stores clothing item information in a structured manner. The server, for each user, maintains a clothing item record table in the database. Each clothing item record includes at least the following fields:
(1) a clothing item identifier, which is a unique key within the system;
(2) a user identifier, associating the clothing item with a specific user;
(3) a higher-level category, representing an abstract type of the clothing item, such as “upper garment,” “lower garment,” or “outer garment”;
(4) a subtype, such as “skirt,” “shirt,” or “jacket”;
(5) one or more color categories, mapped to standardized color families such as “red,” “blue,” or “neutral”;
(6) one or more use attributes, such as “casual,” “business,” or “formal”;
(7) one or more season attributes, such as “spring,” “summer,” or “all-season”;
(8) one or more scene attributes, such as “office,” “date,” or “outdoor”;
(9) an image reference, such as a URL or a file path in an object storage system;
(10) optional additional attributes, such as material, brand category, or size category.

The server, at the time of registration, maps raw attribute input from the terminal (for example, free text or selection values) to standardized higher-level classifications using a mapping table or a rule-based converter. For example, the server maps user-entered “wine red” to a standardized color category “red” and maps a detailed type such as “pencil skirt” to a higher-level subtype “skirt.”

The server stores evaluation information and preference information in additional tables. The server maintains a user feedback table in which each entry includes a user identifier, an outfit proposal identifier or a clothing item identifier, a feedback type (such as “like,” “dislike,” or a numerical rating), a timestamp, and optionally context attributes such as season or scene at the time of evaluation. The server aggregates these entries into preference information, for example by computing frequencies, weighted rating scores, or inferred preference vectors per user, which are also stored in a structured form in the database.

The server stores usage history and browsing history in further tables. These tables can include fields indicating which outfit proposals were displayed, which clothing items were inspected, and which questions were asked, all with timestamps and contextual metadata. The server applies statistical analysis and data mining algorithms to these histories to generate higher-level preference information.

### C. Clothing Registration Behavior

The user, by operating the terminal, registers clothing items. The terminal displays an input screen for entering clothing attributes and, in some embodiments, capturing images via a camera. The terminal converts the attributes into structured data and transmits them to the server.

The server receives item information from the terminal and registers the information in the storage region of the storage device. The server, when receiving a registration request, validates the attributes, maps them into higher-level classifications as described above, and stores a new clothing item record in the database. The server stores image data in the object storage system and records a location reference in the clothing item record. The server thereby maintains an accurate, attribute-rich representation of the user's wardrobe that is optimized for later retrieval.

### D. Natural Language Question Analysis and Attribute Extraction

The user inputs a natural language question via the terminal. The terminal transmits the question text to the server together with the user identifier and optional context data such as current season, location, or occasion.

The server receives the natural language question and performs text analysis to extract attribute information. The server, in one embodiment, uses a natural language processing module built upon a tokenization component, a part-of-speech tagger, an entity recognizer, and pattern-based rule engines. The server tokenizes the question, identifies candidate color adjectives and clothing nouns, and then applies a mapping to the standardized attribute values used in the clothing item records.

For example, if the user inputs, “What tops go well with my red skirt?”, the server detects “red” as a color attribute candidate and “skirt” as a subtype candidate. The server interprets “tops” as a request for an upper garment category. The server then constructs a query object including at least: (i) a reference item target (color: red, subtype: skirt); and (ii) a requested category for combination (category: upper garment).

The server, in another embodiment, uses a small neural text classifier or sequence labeler which is trained to map segments of user questions to attribute categories such as color, category, use, season, and scene. The server, in this case, executes the classifier on the server processor, using a trained network with a limited number of layers, and converts the output label sequence into structured attribute extraction results. The server can combine rule-based and neural-based attribute extraction to improve robustness.

This attribute extraction stage yields a compact representation that directly conditions subsequent database queries. By explicitly mapping natural language tokens to standardized attributes, the server improves retrieval accuracy and reduces unnecessary search space in the storage region.

### E. Attribute-Aware Retrieval of Clothing Item Information

The server uses the extracted attributes to retrieve relevant clothing items from the storage region. The server, for example, first searches for a reference clothing item matching the extracted color and subtype for the given user. The server then retrieves candidate combination items by querying the database for clothing items in the corresponding requested category (for example, upper garments) that belong to the same user.

The server formulates queries that incorporate higher-level classifications, such as “upper garment” and “lower garment,” as well as use, season, and scene attributes when these are specified or inferred. The server, in some embodiments, uses indexing structures, such as composite indexes over user identifier and attribute columns, to accelerate retrieval operations. Because the server uses standardized higher-level classifications, the server reduces index size and improves the efficiency of range searches and equality searches.

The server, in addition, uses preference information to bias the retrieval results. For example, the server can rank candidate items based on historical “like” counts or preference scores and can prioritize items that the user frequently selects or highly rates in similar contexts. The server can also filter out items with low preference scores in the current context.

### F. Construction of Summarized Text-Form Representations

The server converts the retrieved clothing item information into summarized text-form representations suitable for inclusion in a prompt sentence. For each clothing item, the server generates a short phrase including at least the standardized color, the subtype, a length or fit descriptor (if available), and one or more use or scene descriptors. For example, the server can output “red skirt, knee length, casual,” or “white blouse, long-sleeved, suitable for office.”

The server organizes these text summaries into groups by category (for example, “Skirts,” “Tops,” “Shoes”), and in one embodiment, the server imposes a maximum number of items per group to limit prompt length. The server, when the number of items exceeds a threshold, selects representative items based on preference scores or recency of use. This selection step reduces the number of tokens that the generative AI model must process, thereby reducing computational cost and latency.

Because the server uses structured attributes and ranking information to construct these summaries, the server can systematically control which items are exposed to the generative AI model, improving determinism and reproducibility in the generated outfit proposals.

### G. Generative AI Model and Prompt Sentence Construction

The server constructs a prompt sentence for a generative AI model. The server, in one embodiment, uses a prompt template that includes a system role description, a section listing the user's clothing items, and a section describing the user request and constraints.

For example, when the user asks, “What tops go well with my red skirt?”, the server may generate a prompt sentence of the following form:

System: You are a fashion stylist AI. You must propose outfit combinations using only the clothing items that the user owns.

User: The user owns the following items:
Red skirt (knee length, cotton, casual)
White blouse (long-sleeved, cotton, can be worn at the office)
Black T-shirt (short-sleeved, casual)
Navy cardigan (lightweight knit)

Task: The user asks: “What tops go well with my red skirt?”

Please suggest 2-3 outfit ideas that feature the red skirt and choose tops from the listed items.

For each idea, list the items and provide a short explanation (1-3 sentences).

The server, in some embodiments, generates additional constraints in the prompt sentence, such as limitations on output length, prohibition of introducing items not listed, or a requirement to enumerate results in a machine-parseable format. The server can embed instructions such as “Do not suggest any item that is not listed in the user's items” or “Return each outfit on a separate line starting with a numeric index.”

The generative AI model, in one embodiment, is a transformer-based neural network with multiple attention layers, trained on large-scale text corpora to predict next tokens. The model uses tokenization mechanisms (for example, subword tokenization), multi-head self-attention, position encoding, and feed-forward layers. The model parameters (weights) are learned through gradient-based optimization, using a loss function such as cross-entropy between predicted tokens and ground truth tokens in training data. The model is fine-tuned, in some embodiments, on fashion-related corpora and structured styling dialogue data, so that it learns to adhere to instructions about using only listed items and describing outfits.

The server interacts with the generative AI model using a standardized interface, specifying parameters such as a maximum number of output tokens, a temperature controlling randomness, and a top-k or top-p sampling parameter controlling token selection. Because the server provides a prompt sentence that clearly delineates available clothing items and constraints, the model's internal attention mechanism tends to focus on those sections, improving the precision and relevance of the generated proposals.

### H. Post-Processing of Generative Output and Mapping to Internal Identifiers

The server receives the generated text data representing outfit proposals from the generative AI model. The server parses the generated text to identify references to clothing items. The server, for example, performs string matching between clothing item descriptions in the generated text and the standardized names or variants stored in the database. The server may augment this process with an entity recognition component trained to label clothing item names and attributes.

The server then resolves each referenced clothing description to a unique clothing identification information value in the storage region. When multiple candidate records match a description, the server can use additional attributes (such as category, color, or use) to select the best match.

The server builds structured data for each outfit proposal, including a list of clothing identification information entries and the textual explanation for the outfit.

The server, using the clothing identification information, accesses the storage region to retrieve image references and attribute information for each item included in an outfit proposal. The server aggregates these into a data structure that includes, for each proposed outfit, item identifiers, item attributes, and corresponding image references. This mapping operation connects the generative output back to the concrete items maintained in the database, enabling the system to present specific images and to further process the proposals.

Because the server uses this explicit mapping, the server reduces the risk that the user is shown proposals including nonexistent or unavailable items. The server also enables downstream optimization, such as caching of frequently recommended combinations and precomputation of image collages, resulting in reduced latency for repeated queries.

### I. Feedback Acquisition and Preference Adaptation

The user views the outfit proposals on the terminal and provides evaluation information or preference information. The terminal, for example, displays buttons for “like” and “dislike” for each outfit or allows the user to assign numerical scores. The terminal transmits the evaluation information to the server together with identifiers for the outfits and items being evaluated. The server stores evaluation information and aggregates it into preference information. The server performs statistical analysis, such as computing average scores per clothing item and per context (for example, per season or per use), and stores these values. The server may use data mining algorithms, such as clustering similar outfits that the user liked or constructing association rules between attributes and positive feedback, to infer higher-level preferences. The server uses this preference information to adjust both retrieval and prompt construction. For example, the server can assign weights to items in the summarized text-form representations, preferring items with higher preference scores. The server can also adjust the order of items listed in the prompt sentence, so that highly preferred items are placed earlier, thereby increasing their salience in the attention mechanism of the generative AI model. This mechanism exploits the bias of transformer-based models toward earlier or more prominently placed tokens, thereby indirectly steering generation toward preferred items.

Over time, the server, by updating these weights and selection rules based on preference information, automatically adapts the system's behavior to the user's style without requiring explicit manual rule updates by a human operator. This adaptation operates at the database and prompt-construction level, constituting a technical improvement in how the server interacts with the generative AI model and manages user-specific data.

J. Combination with External Product Information

The server, in some embodiments, acquires product information from an online information source. The server accesses an external catalog via a network protocol, obtains product attributes such as category, color, use, season, and image references, and normalizes these attributes into the same higher-level classification scheme used for the user's owned clothing.

The server stores product information in a separate table in the storage region, with identifiers indicating the external source. The server associates product records with user profiles based on inferred preferences, for example by selecting products whose attributes closely match the user's most liked items.

When the server constructs a prompt sentence for the generative AI model, the server can include both owned clothing items and selected product information in the prompt sentence. For example, the server may extend the earlier prompt sentence as follows:

System: You are a fashion stylist AI. You must propose outfit combinations using clothing items that the user owns, and you may optionally suggest additional items from the candidate products listed below.

### User's Items:

Red skirt (knee length, cotton, casual)
White blouse (long-sleeved, cotton, can be worn at the office)
Black T-shirt (short-sleeved, casual)
Navy cardigan (lightweight knit)

### Candidate Products:

Beige cardigan (lightweight knit, suitable for spring)
Patterned scarf (multi-color, casual)
Task: The user asks: “What tops go well with my red skirt?”

Please suggest 2-3 outfit ideas that feature the red skirt, primarily using the user's items, and optionally including at most one candidate product per outfit. For each idea, list the items and provide a short explanation (1-3 sentences).

The server thus allows the generative AI model to consider candidate products in a constrained and well-defined manner. The server can distinguish which items are owned and which items are products, and post-processing can annotate them accordingly, allowing the user to see which components are new acquisitions. The tight integration of owned items and external products in a single prompt sentence, along with the subsequent mapping to internal identifiers, constitutes a technical configuration that enables unified control of generation and more efficient use of external data.

### K. Technical Effects and Improvement of Computer Technology

The described system provides several technical effects beyond mere automation of human judgment.

First, the server's use of higher-level classifications and structured attribute extraction for natural language questions improves the performance of database queries. By translating unstructured language into compact attribute queries, the server reduces the number of candidate items and enables more efficient use of indexes. This leads to faster retrieval times and lower computational load on the database engine.

Second, the server constructs prompt sentences that reflect a constrained and structured view of the user's wardrobe. By selecting and ordering items based on preference information and context-aware rules, the server reduces the token count required for the generative AI model and biases the model's attention towards relevant items. This leads to shorter inference times on the model-serving infrastructure and lower communication bandwidth between the server and the model endpoint, thereby improving computational efficiency and reducing communication load.

Third, the server's post-processing that maps generative outputs back to clothing identification information and augments them with image references creates a repeatable pipeline in which the generative AI model is not merely a black box but an integrated component in a deterministic data flow. This enables caching of commonly requested combinations and pre-rendering of visual layouts, which reduces response latency and CPU consumption on repeated requests.

Fourth, the server's feedback and preference adaptation capability modifies the underlying retrieval and prompt-construction logic in response to user behavior. This adaptation is implemented at the data structure and query level, not by manually tuning business rules, which means that improvements are realized in how the system manages data and constructs inputs for the generative AI model. As a result, the system progressively increases the accuracy of recommendations while using fewer computational resources, because irrelevant items are less frequently retrieved or transmitted.

Fifth, the system, by normalizing external product information into the same attribute schema as owned items and by combining both data sources in a single prompt sentence, creates a unified retrieval and generation pipeline. This avoids duplicative data processing and separate recommendation channels, thereby reducing software complexity and enhancing maintainability. The consistent schema also facilitates indexing and caching strategies that improve throughput.

Furthermore, the use of a transformer-based generative AI model, trained and fine-tuned as described, allows the server to generate diverse and context-sensitive outfit proposals while remaining constrained to the items specified in the prompt. The server, by controlling prompt structure, order, and content, exploits the internal architecture of the generative AI model (in particular, token attention distributions and positional encodings) in a nonconventional way, using prompt engineering and structured representations to achieve technical improvements in relevance, latency, and resource consumption.

In summary, by tightly coupling attribute-aware retrieval, structured prompt sentence construction, neural generation, and post-processing with identifier mapping and feedback adaptation, the system improves computer functionality in the domains of data management, model interaction, and response generation. The system thereby provides a concrete, technically grounded method for coordinating database operations, generative AI computation, and terminal-side presentation in a way that reduces computational waste, improves accuracy, and yields technically advantageous behavior compared with conventional coordination support systems.

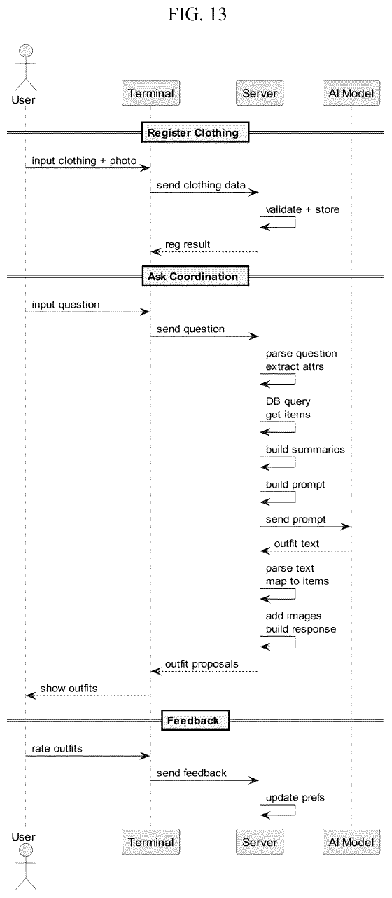

The following describes the processing flow using FIG. 13.

### Step 1:

The user operates the terminal to register a clothing item.

The terminal receives as input raw data including a clothing image captured by a camera and attribute entries such as free-text color, type, brand, size, and intended use.

The terminal converts the input into a structured request by encoding the image into a compressed file format and packaging the attributes into key-value pairs together with a user identifier, and outputs a registration request message addressed to the server.

### Step 2:

The server receives the registration request message from the terminal.

The server takes as input the compressed image file, the raw attribute values, and the user identifier contained in the message.

The server performs data validation and normalization by checking required fields, sanitizing text, and mapping raw attribute values to standardized higher-level classifications (for example, mapping “wine red” to a normalized “red” category and mapping “pencil skirt” to a generalized “skirt” subtype).

The server outputs a normalized clothing item record and an image storage instruction.

### Step 3:

The server stores the clothing item information in the storage device.

The server receives as input the normalized clothing item record and the image storage instruction generated in Step 2.

The server writes the image file to an image storage subsystem and records a storage location reference; the server inserts a database record including a clothing item identifier, the user identifier, normalized attributes, and the image location reference into a clothing item table.

The server outputs a persistent clothing item entry associated with the user and a registration result message for the terminal.

### Step 4:

The terminal receives the registration result message.

The terminal takes as input the registration status and the clothing item identifier returned by the server.

The terminal updates a local representation of the user's wardrobe by appending the new clothing item and refreshes a user interface screen to display the registered item.

The terminal outputs an updated wardrobe display and a confirmation indication to the user.

### Step 5:

The user operates the terminal to issue a coordination question.

The terminal receives as input a natural language question entered by the user, and optionally contextual selections such as occasion, season, and scene.

The terminal packages the question text, context metadata, and the user identifier into a query message addressed to the server.

The terminal outputs this query message as a coordination request.

### Step 6:

The server receives the coordination request from the terminal.

The server takes as input the question text, the context metadata, and the user identifier.

The server records the raw question and context into a question log for traceability and prepares them as analysis inputs for natural language processing.

The server outputs an internal question analysis object initialized with the received data.

### Step 7:

The server analyzes the natural language question to extract attribute information.

The server receives as input the question analysis object containing the question text and context.

The server tokenizes the text, applies part-of-speech tagging, and performs rule-based and/or neural entity recognition to detect color terms, clothing categories, subtypes, uses, seasons, and scenes appearing in the question; the server maps detected terms to standardized attribute codes used in the database schema.

The server outputs an extracted attribute set that represents the interpreted intent of the question, including at least one reference item description and a requested clothing category for combination.

### Step 8:

The server retrieves relevant clothing item information from the storage region based on the extracted attributes.

The server takes as input the user identifier and the extracted attribute set from Step 7.

The server executes attribute-aware database queries: the server first searches for a reference clothing item record belonging to the user that matches the color and subtype attributes, then retrieves candidate combination items in the requested category (for example, all tops) filtered by optional attributes such as season or use.

The server outputs a reference item record and a collection of candidate item records associated with the user.

### Step 9:

The server incorporates preference information into the selection of candidate items.

The server receives as input the collection of candidate item records and the user identifier.

The server queries preference tables to obtain evaluation scores and usage statistics for each candidate item, computes ranking values using statistical formulas or data mining results, and filters or orders the candidate items based on these ranking values.

The server outputs a refined and ranked candidate item list and an updated representation of the reference item.

### Step 10:

The server generates summarized text-form representations of the reference item and the candidate items.

The server takes as input the reference item record and the ranked candidate item list.

The server constructs, for each item, a short phrase including standardized color, subtype, and selected attributes such as length and use; the server groups these phrases by high-level category and applies truncation rules if the number of items exceeds a threshold.

The server outputs a structured summary object containing grouped text descriptions of the user's relevant clothing items.

### Step 11:

The server constructs a prompt sentence for a generative AI model.

The server receives as input the structured summary object, the question text, the extracted attribute set, and system-level constraints.

The server concatenates a system role description, the grouped item descriptions, and a reformulated task description that restates the user's question and constraints, and arranges these segments into a coherent prompt sentence that instructs the generative AI model to use only listed items and to produce a specified output format.

The server outputs a complete prompt sentence ready to be transmitted to the generative AI model.

### Step 12:

The server transmits the prompt sentence to the generative AI model and obtains generated text.

The server takes as input the prompt sentence from Step 11 and model control parameters such as maximum output length and randomness level.

The server sends these as a request to a model-serving interface; the generative AI model internally tokenizes the prompt, performs transformer-based computations using attention layers and learned weights to predict output tokens, and returns generated text representing one or more outfit proposals.

The server outputs the raw generated text data as received from the generative AI model.

### Step 13:

The server parses the generated text to identify referenced clothing items and outfit structures.

The server receives as input the raw generated text and the previously constructed item descriptions.

The server applies pattern matching and entity extraction rules to detect occurrences of clothing names or descriptions in the generated text, aligns these with the stored item descriptions or standardized attributes, and segments the text into discrete outfit proposals with associated explanatory sentences.

The server outputs a set of intermediate outfit structures, each containing textual references to specific items and attached explanation text.

### Step 14:

The server maps textual references in the outfit structures to clothing identification information in the storage region.

The server takes as input the intermediate outfit structures and the clothing item records retrieved in Step 8 and Step 9.

The server, for each textual reference, computes similarity metrics against item names and attributes, selects the best-matching clothing item record, and assigns the corresponding clothing item identifier; items without reliable matches are excluded or flagged.

The server outputs finalized outfit structures in which each referenced item is replaced by a concrete clothing identification information entry.

### Step 15:

The server augments the outfit structures with image information and attribute details.

The server receives as input the finalized outfit structures and uses the clothing identification information to access the storage region.

The server retrieves image references and key attributes such as color and category for each identified item, attaches these to the corresponding outfit structure, and formats the enriched structures into a presentation-oriented data representation including item lists, explanation text, and image locations.

The server outputs a presentation data object suitable for rendering on the terminal.

### Step 16:

The server transmits the presentation data to the terminal.

The server takes as input the presentation data object from Step 15 and the destination terminal identifier.

The server serializes the presentation data into a response message, sends it over the network to the terminal, and records a log entry linking the question, prompt sentence, model response, and presentation data for diagnostic and analytical purposes.

The server outputs the transmitted response and an updated log in the storage region.

### Step 17:

The terminal receives and renders the presentation data.

The terminal takes as input the response message containing the presentation data.

The terminal parses the outfit structures, loads referenced images from the indicated locations, and constructs a graphical user interface layout that displays, for each outfit, the associated item images and explanation text in a human-readable arrangement.

The terminal outputs a visual presentation of outfit proposals on the display and an internal representation of the displayed outfits for possible user interaction.

### Step 18:

The user interacts with the displayed outfit proposals and provides evaluation information.

The terminal receives as input user actions such as selecting an outfit, pressing a “like” or “dislike” control, or assigning a numerical rating to an outfit.

The terminal encodes these actions into evaluation information including identifiers of the evaluated outfit and items, the type of feedback, and optional contextual metadata, and packages them into a feedback message addressed to the server.

The terminal outputs this feedback message as user evaluation data.

### Step 19:

The server receives the feedback message and updates preference information.

The server takes as input the evaluation information from the terminal.

The server stores the evaluation entries in a feedback table, aggregates them with existing records by computing updated statistics such as average scores and counts, and refreshes preference vectors or ranking weights associated with the user and the evaluated items.

The server outputs updated preference information in the storage region and an acknowledgment message to the terminal.

### Step 20:

The server adapts future retrieval and prompt construction based on the updated preference information.

The server receives as input the updated preference information and internal configuration parameters that govern weighting and selection strategies.

The server adjusts retrieval rules by modifying thresholds for including or excluding items based on preference scores, updates ranking formulas used in candidate selection, and modifies prompt construction templates to emphasize or de-emphasize specific attribute combinations according to learned preferences.

The server outputs updated retrieval and prompt-generation configurations that influence subsequent executions of Step 8 through Step 11, thereby altering future data processing and generative AI model interactions in response to accumulated user behavior.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented fashion recommendation systems suffer from several technical limitations that reduce their effectiveness and scalability. First, typical systems process heterogeneous context data-such as weather data, user wardrobe data, purchase and browsing histories, and emotion-related data from sensors and user input-in separate, loosely coupled modules. As a result, the systems are unable to generate a unified internal representation that can be efficiently consumed by a generative artificial intelligence model, leading to suboptimal use of computing resources and degraded recommendation quality.

Second, conventional systems generally treat large language models or other generative artificial intelligence models as simple text generators, without a structured mechanism for constructing prompt sentences that encode multi-dimensional context including environment conditions, user attributes, and real-time feedback. This ad hoc prompting approach prevents deterministic control over model behavior, makes the output unstable, and complicates system-level optimization, such as caching, ranking, or iterative refinement based on user reactions.

Third, existing systems often lack an integrated feedback loop that uses explicit user feedback and implicit emotional reactions as learning data for updating user preference profiles and for automatically refining prompt generation logic. In many implementations, user feedback and emotion logs are stored as isolated records, without being systematically incorporated into the computational pipeline that generates future recommendations. This leads to redundant processing of raw data, inefficient database access patterns, and an inability to adapt the system's behavior at the prompt-construction layer, which is the primary interface to the generative artificial intelligence model.

Fourth, conventional virtual try-on or coordination visualization functions are typically disconnected from the reasoning performed by the recommendation engine. The mapping from natural-language recommendation output to concrete wardrobe items and digital product records is either manual or based on brittle string matching, causing failures when the generated text refers to items abstractly. This lack of a robust mapping layer prevents the system from reliably constructing visualization data, such as coordination images in a virtual display space, resulting in a fragmented user experience and additional computational overhead for reconciliation between text and structured data.

From the perspective of computer technology, there is therefore a need for an improved information processing system and server architecture that (i) unifies heterogeneous user-related and environment-related data into a machine-usable context, (ii) programmatically generates structured prompt sentences as inputs to a generative artificial intelligence model, (iii) maintains and updates user attribute information and prompt generation logic using stored feedback and emotion record information as learning data, and (iv) reliably maps generated proposal information back to structured clothing management information and external product information to drive coordinated visualization in a virtual display space. Such an architecture should improve the efficiency, controllability, and adaptability of the overall computing system, rather than merely automating human fashion advice.

The specific processing by the specific processing unit 290 of the data processing device 12 in Application Example 2 is realized by the following means.

The present invention provides a server comprising a processor and one or more storage devices configured to store clothing management information, history record information, user attribute information, emotion record information, product information, prompt sentences, and proposal information, and the processor is configured to acquire location information and time information of a user from a terminal apparatus, acquire weather information corresponding to the location information from an external information providing apparatus, and determine a combination of clothing suitable for the user based on the weather information; to receive clothing information input by the user through the terminal apparatus, register the clothing information as clothing management information in the storage device, and extract combination candidates of clothing owned by the user based on the clothing management information; to obtain past purchase history information and browsing history information of the user as history record information from the storage device, analyze the history record information by using at least one of a statistical processing method and a machine learning method, and generate user attribute information indicating preference information and style information of the user; to obtain product information from an external information source, filter the product information based on the user attribute information and the weather information, and select candidate clothing information to be presented to the user; to receive input text information of the user and at least one of image information and audio information acquired by the terminal apparatus, input the input text information and the at least one of the image information and the audio information to an emotion analysis processing unit to obtain emotion state information, store the emotion state information as emotion record information in the storage device, and adjust a priority of the combination candidates of clothing and a priority of the candidate clothing information in accordance with the emotion state information; to generate, based on the weather information, the clothing management information, the user attribute information, the candidate clothing information, and the emotion state information, a prompt sentence to be input to a generative artificial intelligence model, transmit the prompt sentence to the generative artificial intelligence model, obtain proposal information expressed in natural language from the generative artificial intelligence model, and generate clothing proposal information to be presented to the user based on the proposal information; to transmit the clothing proposal information to the terminal apparatus and cause the terminal apparatus to display the clothing proposal information as image information and text information; to obtain preference information and purchase information of the user with respect to the clothing proposal information as feedback information, store the feedback information in association with the emotion record information as learning data in the storage device, and update the user attribute information and a process for generating the prompt sentence based on the learning data; and, in certain embodiments, to analyze a correspondence between the proposal information and the clothing management information and the product information, identify clothing elements included in the proposal information, specify clothing management information and product information corresponding to the clothing elements, generate coordination image data in a virtual display space by using the specified clothing management information and product information, output the coordination image data to the terminal apparatus such that a combination of clothing owned by the user and new products can be visually confirmed in the virtual display space, and, in further embodiments, store dialogue information and evaluation information as session information, generate new prompt sentences based on past prompt sentences and past proposal results including the session information, and perform continuous clothing proposal taking into account a dialogue history with the user. This enables the computing system to construct and maintain an integrated machine-readable context, to generate and adapt structured prompt sentences for a generative artificial intelligence model, and to close a feedback loop that updates both user profile data and prompt generation logic, thereby improving the technical operation of the server-based recommendation engine, enhancing control over generative model behavior, reducing redundant processing of heterogeneous data, and enabling reliable mapping from natural-language output to structured data for virtual coordination visualization.

The term “system” refers to a combination of one or more computing devices, including at least a server apparatus and one or more terminal apparatuses, that cooperatively execute programmed instructions to perform the processes described herein.

The term “processor” refers to one or more hardware processing units, such as a central processing unit, a graphics processing unit, or a dedicated logic circuit, that execute machine-readable instructions to implement the described functions.

The term “storage device” refers to any non-transitory computer-readable medium, such as a memory or a storage unit, configured to store data, parameters, models, and program code used by the processor.

The term “terminal apparatus” refers to an information processing device operated by a user, such as a portable terminal, a wearable terminal, or a display-equipped computing terminal, configured to transmit data to and receive data from the server apparatus and to provide a user interface.

The term “server” refers to an information processing apparatus including the processor and the storage device, configured to provide data processing, analysis, and recommendation services to the terminal apparatus over a communication network.

The term “location information” refers to data indicating a geographical position of the terminal apparatus or the user, such as coordinates, region identifiers, or other position-related attributes.

The term “time information” refers to data indicating a temporal context associated with the user or the terminal apparatus, such as date, time of day, or time zone.

The term “external information providing apparatus” refers to an external computing resource or service that supplies environment-related or content-related data, such as weather information or product information, to the server.

The term “weather information” refers to data representing environmental conditions at a geographical location, including but not limited to temperature, precipitation, cloud cover, humidity, and weather condition type.

The term “clothing information” refers to data describing an item of clothing or an accessory, including at least an item type, color, style, and optionally size, brand, material, and associated image data.

The term “clothing management information” refers to structured clothing information that has been registered in the storage device and associated with a particular user for use in wardrobe management and coordination generation.

The term “combination of clothing” refers to a set of two or more items represented by clothing management information and/or product information, selected to be worn together as an outfit.

The term “combination candidates of clothing” refers to multiple alternative sets of clothing items generated by the processor based on the clothing management information and other contextual data.

The term “past purchase history information” refers to data indicating items that the user has previously acquired, including identifiers, categories, colors, prices, and acquisition times.

The term “browsing history information” refers to data indicating items or content that the user has previously viewed or accessed, including identifiers, categories, and viewing times.

The term “history record information” refers to a collection of past purchase history information and browsing history information associated with a user.

The term “statistical processing method” refers to a computational procedure that applies statistical analysis to data, such as aggregation, frequency computation, or distribution estimation, to derive user-related characteristics.

The term “machine learning method” refers to a computational procedure in which a trained model processes input data to generate outputs such as preference scores, classifications, or predictions.

The term “user attribute information” refers to structured data representing characteristics of a user derived from history record information, including preference information and style information.

The term “preference information” refers to data representing tendencies of a user to favor particular categories, colors, styles, price ranges, or other attributes of clothing items.

The term “style information” refers to data representing stylistic characteristics associated with a user, such as casual, formal, sporty, or other style-related classifications.

The term “external information source” refers to an external computing resource or service that provides product-related or content-related information, such as an online catalog or a commerce platform.

The term “product information” refers to structured data describing a product obtainable from an external information source, including at least a category, attributes, and an identifier.

The term “candidate clothing information” refers to product information selected by the processor as suitable to be proposed to the user based on user attribute information and contextual conditions.

The term “input text information” refers to character-based data representing natural-language content or commands that the user enters via the terminal apparatus.

The term “image information” refers to data representing visual content obtained by an imaging device, such as a camera, associated with the terminal apparatus.

The term “audio information” refers to data representing sound signals obtained by an audio input device, such as a microphone, associated with the terminal apparatus.

The term “emotion analysis processing unit” refers to a software-implemented or hardware-assisted component configured to receive at least one of text, image, and audio data, and to output emotion state information by applying emotion analysis algorithms.

The term “emotion state information” refers to data representing an estimated emotional condition of the user, such as labels, scores, or probabilities associated with emotional categories.

The term “emotion record information” refers to data structures in the storage device that store emotion state information in association with user identifiers, time information, and optionally context information.

The term “priority” refers to a numerical or ordinal value used by the processor to rank combination candidates of clothing or candidate clothing information relative to one another for selection or presentation.

The term “generative artificial intelligence model” refers to a trained computational model configured to receive a prompt sentence as input and to generate natural-language output based on the content of the prompt sentence.

The term “prompt sentence” refers to a text-based instruction or context description generated by the processor and provided as input to the generative artificial intelligence model to control the content and format of the model's output.

The term “proposal information” refers to natural-language output generated by the generative artificial intelligence model in response to a prompt sentence, including recommendations, explanations, or descriptions related to clothing combinations.

The term “clothing proposal information” refers to structured data derived from the proposal information and formatted for presentation to the user, including selected items, outfits, and associated explanatory text.

The term “image information and text information” refers to a combination of visual data and character-based data that is rendered by the terminal apparatus to present clothing proposal information to the user.

The term “feedback information” refers to data representing user responses to the clothing proposal information, including preference information, selection actions, and purchase-related actions.

The term “learning data” refers to data used to adjust parameters, rules, or models within the system, including at least feedback information stored in association with emotion record information.

The term “process for generating the prompt sentence” refers to a computational procedure executed by the processor to construct a prompt sentence from contextual data, including selection, ordering, and formatting of content elements.

The term “virtual display space” refers to a computer-generated visual environment in which representations of clothing items and outfits are rendered for display on the terminal apparatus.

The term “coordination image data” refers to image data representing at least one combination of clothing items, generated for presentation in the virtual display space.

The term “clothing elements” refers to abstract or concrete identifiers of clothing-related components contained in the proposal information, such as item types, colors, or attributes that can be mapped to structured clothing management information or product information.

The term “dialogue information” refers to a sequence of user inputs, system outputs, and intermediate messages exchanged between the user and the system during a consultation session.

The term “evaluation information” refers to explicit user assessments of the clothing proposal information, such as ratings, likes, dislikes, or comments.

The term “session information” refers to data representing a collection of dialogue information and evaluation information associated with a particular interaction session between the user and the system.

The term “continuous clothing proposal” refers to iterative generation and presentation of clothing proposal information over time within an ongoing interaction, in which subsequent proposals are influenced by prior dialogue history and feedback.

In one embodiment, a server, a terminal, and a user cooperate to implement the claimed system. The server includes at least one processor and one or more storage devices connected via an internal bus, and communicates with the terminal via a communication network such as the Internet. The terminal includes at least a processor, a memory, a display, an input interface (touch panel, keyboard, or microphone), a camera, a location sensor such as a GPS module, and a wireless communication interface.

The server executes a program stored in the storage device. The program is implemented, for example, using an application framework such as a web application framework running on an operating system. The server uses a relational database management system such as a relational database engine to store clothing management information, history record information, user attribute information, emotion record information, product information, prompt sentences, and proposal information. The server uses a data analysis library such as a table-based numerical computation library and a machine learning library such as a tensor computation framework to analyze user history and to train and apply models. The server communicates with external information providers, such as weather information services and product information services, via HTTP or HTTPS.

The terminal executes an application program, for example a native or cross-platform mobile application framework, which provides user interfaces for wardrobe registration, text or voice input, emotion capture, and visualization of clothing proposal information. The terminal acquires location information using its GPS module, acquires time information from its system clock, captures images using its built-in camera, and captures audio using its built-in microphone. The terminal transmits these data items to the server and receives clothing proposal information, including image information and text information, from the server.

The server acquires location information and time information transmitted by the terminal and calls an external weather information API. The server transmits a request message including latitude and longitude and receives weather information in a structured format such as JSON.

The server parses the received document to extract fields such as temperature, precipitation, humidity, and a symbolic weather condition code. The server stores the extracted fields into normalized tables in the relational database, for example a weather log table, linked to the user identifier and a session identifier.

The server receives clothing information from the terminal, for example clothing type, color, style, and optionally brand and size, together with an image of each item. The server stores a record in a wardrobe_items table for each clothing item, with columns for user_id, item_id, type, color, style_tag, and an image_path referencing file storage. The server optionally performs pre-processing on the uploaded images, such as resizing and format conversion, to standardize image dimensions and reduce storage size. The server maintains indices on columns such as user_id, type, and color to accelerate subsequent search operations.

The server stores past purchase history information and browsing history information into separate tables. For each purchase, the server stores at least user_id, product_id, category, color, price, and purchase_time. For each browsing event, the server stores user_id, product_id, view_time, and optionally dwell time. The server periodically or on demand loads these tables into in-memory data structures, such as data frames, and computes aggregate statistics. The server computes, for example, frequency of categories, empirical distributions of colors and price ranges, and transition frequencies between item types.

In one embodiment, the server constructs features for each user by encoding category preferences, color preferences, price preferences, and brand preferences as numerical vectors.

The server uses a machine learning library such as a tensor-based framework to implement a multi-layer neural network that receives these features as input and outputs a user preference embedding. The neural network architecture may include an input layer sized to the number of distinct categories, colors, and price bins, one or more hidden layers with rectified linear unit (ReLU) activation functions, and an output layer representing a dense preference embedding.

The server trains this network offline using historical data from multiple users, with a loss function defined, for example, as a cross-entropy between predicted and actual purchased categories, or a ranking loss that encourages high scores for purchased items relative to non-purchased items. During training, the server updates weights using gradient descent or an adaptive method, and optionally applies regularization and data augmentation, such as random sub-sampling of history sequences, to improve generalization.

At runtime, the server applies the trained model to each user's feature vector to compute user attribute information, including numeric preference scores for categories, colors, and styles, and a low-dimensional embedding representing the user's style. By representing preferences as numeric vectors rather than as ad hoc tags, the server can perform similarity computations between users and products efficiently using vector operations. This improves the speed and scalability of matching operations and reduces database join complexity compared to manually coded rules, which constitutes an improvement in computer-implemented data management and matching.

The server obtains product information from external information sources, such as online product catalogs, via web APIs or web scraping. The server receives structured product information including product_id, category, attributes, price, and image URLs. The server stores these records in a product_catalog table and maintains indices by category, color, and price. The server filters product information based on user attribute information and weather information using vector operations and database queries. For example, the server may compute similarity between the user's preference embedding and each product's attribute vector (constructed from category, color, and price bin encodings) and discard products whose similarity falls below a threshold. This computational matching reduces the candidate set before passing any information to a generative AI model, thereby decreasing communication overhead and token usage when constructing prompt sentences.

The server receives input text information from the user, such as “I am looking for a new jacket” or “What should I wear today?”, via the terminal. The server sends the input text to an emotion analysis processing unit implemented with a natural language sentiment analysis tool and optionally sends image information and audio information (such as a face image or voice sample) to a multimodal emotion classifier. The emotion analysis processing unit may implement, for example, a recurrent neural network, a transformer-based classifier, or a convolutional neural network for images, trained with labeled emotion data. The server obtains emotion state information such as “joy”, “neutral”, or “sad”, along with confidence scores. The server stores this emotion state information in an emotion_log table together with user_id, time, and session_id.

The server adjusts priorities of combination candidates of clothing and candidate clothing information based on the emotion state information. For example, when the user is classified as “sad”, the server increases scores of outfits that contain soft colors or comfortable fabrics and decreases scores of highly formal or visually aggressive items. The server stores such adjustment rules as data structures, such as weight vectors applied to particular style tags or color groups. The processing thus incorporates a non-human, rule-based adjustment layer that modulates candidate rankings using emotion labels rather than simply mirroring human judgment. This allows the system to apply consistent and quantifiable transformations to ranking scores, which is different from merely replicating human cognitive processes.

The server generates prompt sentences to be provided to a generative AI model. The server constructs each prompt sentence by concatenating structured segments including weather information, clothing management information (a selected subset of wardrobe items), user attribute information, candidate clothing information, and emotion state information. The server uses templates and rule-based ordering: for example, the server always places weather conditions and emotion labels before listing user wardrobe items, and always lists candidate new products at the end of the prompt sentence. By enforcing a deterministic template, the server improves the predictability and consistency of the generative AI model's outputs and facilitates downstream parsing of proposal information.

Examples of prompt sentences generated by the server include:

“The user says: ‘I am looking for a new jacket.’ The current weather is cloudy and 18 degrees Celsius. The user feels slightly stressed. The user's style profile shows a preference for casual dark-colored jackets and mid-range prices. The user owns the following items: (1) blue jeans, (2) white T-shirt, and (3) black leather boots. The online store currently offers the following jackets: [A] casual black cotton jacket, [B] navy waterproof jacket, and [C] gray wool blazer.

Using this information, please recommend three jackets and explain: (a) why each jacket suits the user's style and emotion, and (b) how each jacket can be combined with the existing wardrobe to create an outfit suitable for today's weather.”

“The user feels sad and wants something comfortable. The weather is rainy and 12 degrees Celsius. The user owns: (1) navy trench coat, (2) gray sweater, (3) black trousers, and (4) white sneakers. Please propose several outfits using these items that are suitable for the weather and may help the user feel calm, and briefly explain your choices.”

“The current weather is sunny and 25 degrees Celsius. The user is excited and is planning a weekend outing. The user has the following clothes: white shirt, light blue jeans, and brown loafers. The user asks: ‘What should I wear today?’ Please propose at least two outfits, including color accents, that match this mood and explain the reasons.”

The server transmits each prompt sentence to a generative AI model through an API. The generative AI model may be, for example, a transformer-based language model with multiple self-attention layers, trained on a large corpus of text, and fine-tuned optionally on fashion-specific texts. The server specifies parameters such as maximum tokens, temperature, and output style in the API call. By constructing prompt sentences that include structured and filtered data, the server reduces the amount of irrelevant information sent to the generative AI model and thereby reduces token usage and response time, which is a measurable improvement in computational efficiency.

The server receives proposal information as natural-language text from the generative AI model. The server parses the text using pattern matching and semantic analysis to identify clothing elements such as item types (“jacket”, “pants”), colors (“black”, “white”), and optional descriptors (“casual”, “formal”). The server maps these elements to clothing management information and product information stored in the database. For mapping, the server uses pre-computed dictionaries and vector similarity between label embeddings and stored attribute labels. This mapping process uses machine-readable attribute structures and numeric similarity metrics instead of relying solely on string matching, which makes the mapping more robust to variations in wording. The server thus converts the proposal information into clothing proposal information, which includes specific wardrobe item IDs and product IDs.

The server generates coordination image data for visualization in a virtual display space. The server selects image files corresponding to the wardrobe items and products referenced in the clothing proposal information and composes them into layout templates. The server may generate sprite coordinates or scene graph descriptions that determine the placement and layering of 2D images or 3D models on the display. The terminal renders these structures as composite images or simple augmented reality scenes, allowing the user to visually confirm combinations of owned clothing and candidate new items. This joint processing of generative text output and structured data to drive display composition constitutes a specific improvement in the way the computer system handles multimodal data integration.

The server transmits the clothing proposal information and associated coordination image data to the terminal, which displays them on a screen as text and images. The user observes the outfits, provides explicit feedback, for example pressing “like” or “dislike” buttons or entering comments, and optionally selects items for purchase. The terminal sends preference information and purchase information back to the server. The server records these as feedback information in a feedback_log table, linking them to the recommendation identifiers, prompt sentences, and emotion record information.

The server uses feedback information and emotion record information as learning data. In one embodiment, the server periodically retrains or fine-tunes its user preference model and its prompt generation rules. The server computes, for example, that certain combinations of weather conditions, emotion labels, and style tags are frequently associated with positive feedback. The server then adjusts weights in the ranking rules and, in another embodiment, updates prompt templates to emphasize those conditions that historically lead to successful recommendations. This dynamic adjustment of both model parameters and prompt generation enables the computing system to adapt its internal behavior in a way that improves recommendation accuracy and reduces the number of interactions needed for the user to find a satisfactory outfit.

The server stores dialogue information and evaluation information as session information. The server maintains, for each session, a chronological log of user inputs, generated prompt sentences, proposal information, and feedback. When the user continues the consultation and submits further requests, the server uses the stored session information to build new prompt sentences that refer to past proposals. For example, the server may generate a prompt sentence such as:

“Previously, you recommended the following outfit: blue jeans, white T-shirt, and black leather boots with a casual black jacket. The user now requests: ‘Please suggest a more formal version of this outfit for an office meeting.’ Based on the user's preferences, wardrobe items, and current weather (cloudy, 18 degrees Celsius), please propose a more formal outfit, reusing items when possible, and explain the changes.”

By maintaining session-level state and constructing prompts that capture this history, the server reduces redundant re-processing of base data and allows the generative AI model to operate on concise, incremental context rather than full re-descriptions of user data. This yields a reduction in communication load and computational overhead, and supports continuous clothing proposal that is technically distinct from isolated, stateless text generation.

In another embodiment, the server employs alternative machine learning models for user attribute information generation, such as matrix factorization models, graph neural networks for user-item relationships, or sequence models that capture temporal dynamics of purchases. The server may also use different emotion analysis algorithms, such as support vector machines or random forests over handcrafted features, depending on data availability and resource constraints. In further embodiments, the generative AI model may be hosted locally or remotely; the server may cache frequent prompt sentence and response pairs; and the server may apply compression techniques to reduce size of stored logs.

The described architecture provides technical effects beyond automation of human stylist behavior. The server introduces specific data structures (normalized tables for weather log, wardrobe_items, product_catalog, emotion_log, feedback_log, and user_style_profile), deterministic prompt templates, optimized filtering and ranking algorithms, and learning loops that refine both internal models and prompt sentences based on machine-readable feedback. As a result, the system improves processing speed by reducing the number of candidate items and tokens sent to the generative AI model; improves accuracy by fusing structured preference vectors, emotion labels, and environment data before generation; reduces error rates in mapping natural language output back to structured identifiers; and lowers communication and computation load by re-using session context. These characteristics show that the system changes and improves how the computer stores, processes, and uses data to generate and visualize fashion recommendations, rather than merely computerizing a human stylist's workflow.

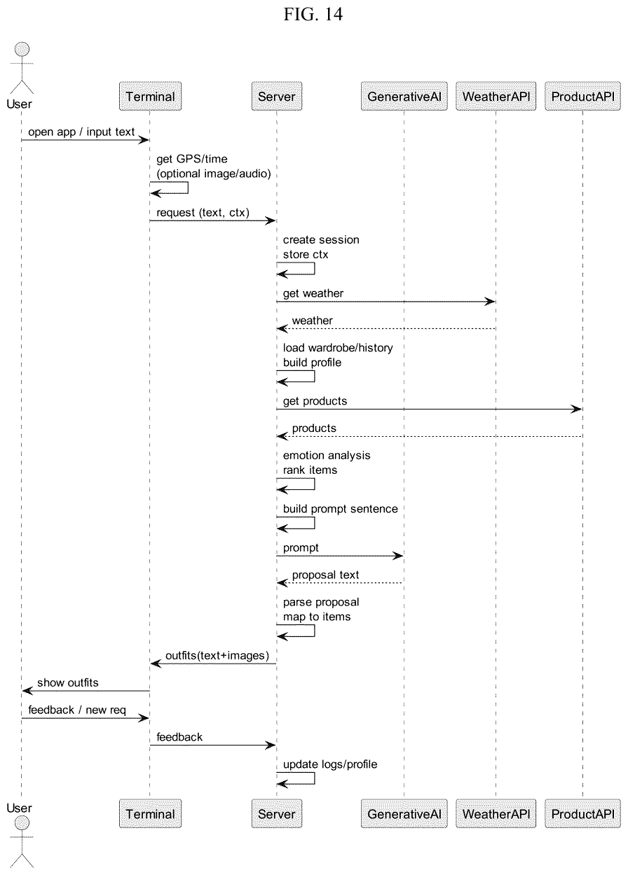

The following describes the processing flow using FIG. 14.

### Step 1:

The user activates the application on the terminal and initiates a fashion consultation. The user inputs text such as “I am looking for a new jacket” or “What should I wear today?” via a touch interface or a keyboard, and optionally permits the terminal to access the camera, microphone, and location sensor. The input of this step is user operation and natural-language text, and the output is a structured request object held in the terminal's memory that contains at least the text, a user identifier, and permission flags for sensors.

### Step 2:

The terminal acquires sensor data and context information. The terminal reads GPS coordinates from a GPS module, reads current date and time from a system clock, captures an image of the user's face using the camera if permitted, and records a short audio snippet using the microphone if voice input or emotion analysis is enabled. The input to this step is the user's permission and the initial request object from Step 1, and the output is an extended request object including text, user_id, location, time, optional image data, and optional audio data.

### Step 3:

The terminal transmits the extended request object to the server. The terminal converts the object into a structured message, for example JSON, and sends it via HTTPS to a server endpoint dedicated to consultation requests. The input to this step is the extended request object in the terminal, and the output is a network message delivered to the server containing user text, context, and sensor data.

### Step 4:

The server receives the request and initializes a session. The server parses the received JSON, validates the user_id, and creates a new session record in a session table of a database, storing user_id, timestamp, and a reference to the raw request. The input to this step is the network message from Step 3, and the output is a session identifier and stored session metadata that are used to associate subsequent processing with this interaction.

### Step 5:

The server acquires weather information based on the location information. The server extracts latitude and longitude from the request data and calls an external weather API with these parameters. The server receives a JSON document containing fields such as temperature, humidity, and weather condition codes, parses these fields with a JSON parser, and stores them in a weather_log table linked to the session_id. The input to this step is the location information from the user request, and the output is a normalized weather record in the database and a weather context object in memory that will be reused in later processing.

### Step 6:

The server retrieves and prepares wardrobe data. The server executes SQL queries against a wardrobe_items table to obtain all clothing items associated with the user_id, including types, colors, styles, and image references. The server loads these rows into an in-memory data structure such as a list or data frame and may filter by season or category based on the weather context (for example, excluding heavy coats when the temperature is high). The input to this step is the user id obtained in Step 4, and the output is a structured wardrobe list that contains eligible owned items for potential combinations.

### Step 7:

The server retrieves and analyzes user history to generate user attribute information. The server queries purchase_history and view_history tables using the user_id to collect past purchase and browsing records. The server loads these records into data frames and computes aggregates such as category frequencies, color distributions, and typical price ranges by applying group-by and count operations. The server builds a feature vector that encodes these statistics and passes this vector into a preference model, such as a trained neural network implemented in a machine learning framework. The model outputs a numerical preference embedding and per-category scores. The input to this step is the history record information from the database, and the output is user attribute information representing quantified preferences and styles.

### Step 8:

The server collects candidate products from external information sources. The server uses user attribute information and weather context to build search filters, such as desired categories, color ranges, and price intervals, and calls external product APIs or fetches product lists from online sources. The server parses the returned product data, normalizes fields such as category and color, and stores or updates records in a product_catalog table. The server then filters the catalog in memory or via SQL queries to obtain candidate products that match the user's style and current conditions. The input to this step is user attribute information and weather context, and the output is a set of candidate clothing information entries representing potential new items.

### Step 9:

The server analyzes user emotion based on text and optional media. The server forwards the input text to a text-based emotion classifier and, if available, forwards the face image and audio snippet to image-based and audio-based emotion classifiers. Each classifier outputs emotion scores or labels such as “joy”, “neutral”, or “sad” with associated confidence values. The server combines these outputs, for example by weighted averaging or rule-based selection, to determine a final emotion state information for the session. The server stores this emotion state in an emotion_log table. The input to this step is the user's text, image, and audio data from the request, and the output is a consolidated emotion label and associated scores recorded as emotion record information.

### Step 10:

The server adjusts ranking priorities for owned and candidate items according to the emotion state. The server reads combination rules that map emotion labels to weight adjustments on color, style tags, or formality. The server applies these weights to existing scores of wardrobe items and candidate products by multiplying or adding weight factors to their ranking scores.

For example, when the emotion is “stressed”, the server increases scores of “comfortable” and “calm color” items and decreases scores of “bright” or “highly formal” items. The input to this step is the emotion state information and previously computed base scores for items, and the output is updated priority values for combination candidates and candidate clothing information.

### Step 11:

The server selects a subset of items and combinations to be passed into a generative AI model context. The server uses the updated priorities to choose a limited number of top wardrobe items and top candidate products to keep prompt length manageable. The server may pre-generate a few combination skeletons by algorithmically pairing tops, bottoms, and outerwear based on category compatibility. The input to this step is the ranked wardrobe list and ranked product list from earlier steps, and the output is a reduced, high-relevance set of items and combination skeletons that will be encoded into a prompt sentence.

### Step 12:

The server constructs a prompt sentence for the generative AI model. The server arranges weather context, emotion state, user attribute summaries, selected wardrobe items, and candidate products into a carefully structured natural-language description using pre-defined templates. The server inserts user text such as “I am looking for a new jacket” and enumerates items in a consistent order, for example listing owned items before new products. The input to this step is the context information from Steps S through 11, and the output is a single prompt sentence or a small set of prompt sentences that fully describe the situation for the generative AI model.

### Step 13:

The server transmits the prompt sentence to the generative AI model and obtains proposal information. The server calls an API of the generative AI model, specifying model parameters such as maximum output length and creativity level, and passes the prompt sentence as input text. The generative AI model generates natural-language proposals such as recommended outfits and explanations, and the server receives this output as plain text. The input to this step is the prompt sentence from Step 12, and the output is proposal information expressed as natural language describing recommended combinations and reasons.

### Step 14:

The server parses the proposal information and maps it to structured clothing elements. The server analyzes the generated text using pattern matching and semantic extraction to identify clothing elements such as item types, colors, and style modifiers. The server then matches these extracted elements against clothing management information in the wardrobe_items table and product information in the product_catalog table, using both exact matches and similarity measures where necessary. The input to this step is the natural-language proposal information, and the output is clothing proposal information that lists specific wardrobe item IDs and product IDs for each recommended outfit.

### Step 15:

The server generates coordination image data and presentation structures. The server retrieves image references for the identified wardrobe items and candidate products, determines layout templates for displaying multiple items together, and composes metadata describing how images should be arranged in a virtual display space, such as layering order and positions. The server bundles this visual composition metadata with descriptive text for each outfit. The input to this step is clothing proposal information containing item identifiers, and the output is a structured response object containing visual layout data and textual explanations.

### Step 16:

The server sends the structured response object to the terminal. The server serializes the clothing proposal information and coordination image data into a response message, for example as JSON, and transmits this message via HTTPS to the terminal that issued the original request. The input to this step is the structured response object prepared in Step 15, and the output is a network response that the terminal receives and stores in its memory for display processing.

### Step 17:

The terminal receives the response and renders the clothing proposal information. The terminal parses the received JSON, downloads any referenced images not already cached, and displays outfits as sets of images and text on the display. The terminal arranges items according to the layout metadata and shows explanations such as “Your blue jeans and white T-shirt with this black casual jacket will suit today's cool, cloudy weather and help you feel relaxed.” The input to this step is the network response from Step 16, and the output is a graphical user interface presented to the user showing multiple outfit options.

### Step 18:

The user reviews the proposals and provides feedback or makes selections. The user may tap buttons such as “like”, “dislike”, or “show details”, or select a product for purchase. The user may also enter additional text such as “Please suggest a more formal version.” The input to this step is the displayed clothing proposal information, and the output is user interaction events and additional text commands captured by the terminal.

### Step 19:

The terminal transmits feedback information and any additional requests to the server. The terminal packages user actions, such as outfit_liked, outfit_disliked, product_clicked, and new text input, together with associated outfit IDs and product IDs, into a feedback message. The terminal sends this message via HTTPS to feedback and dialogue endpoints on the server. The input to this step is the interaction events and text from Step 18, and the output is a feedback message delivered to the server containing explicit user preferences and follow-up requests.

### Step 20:

The server records feedback information and updates learning data. The server writes feedback entries into a feedback_log table, linking them with session_id, recommendation_id, and emotion record information previously stored. The server updates aggregate statistics for the user, such as counts of accepted and rejected outfits by type or color, and may adjust user attribute information or ranking weights. The input to this step is the feedback message from Step 19 and existing logs in the database, and the output is updated learning data that will influence future scoring, prompt sentence construction, and recommendation behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

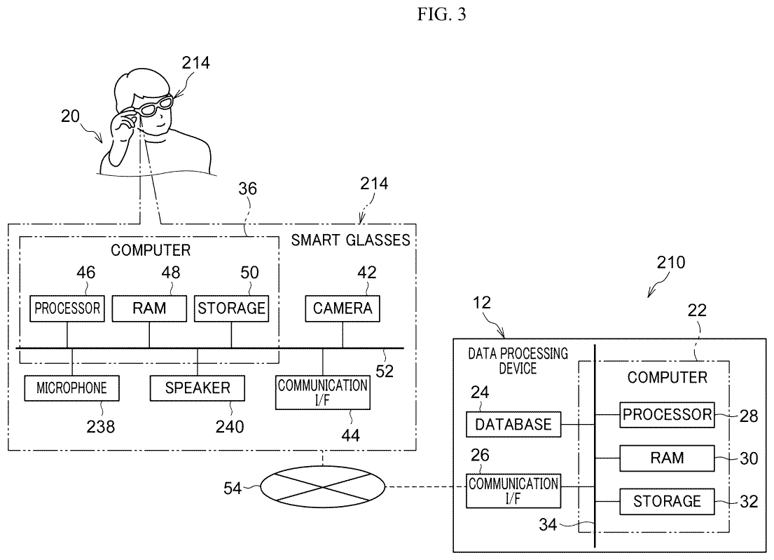

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46.

The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

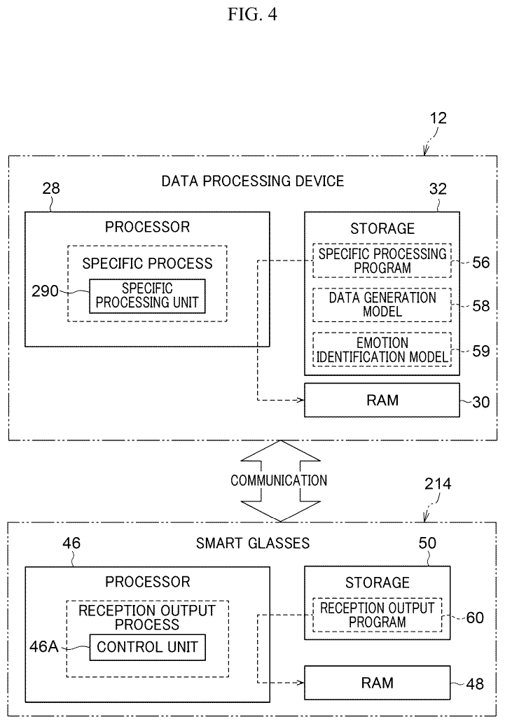

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12.

The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

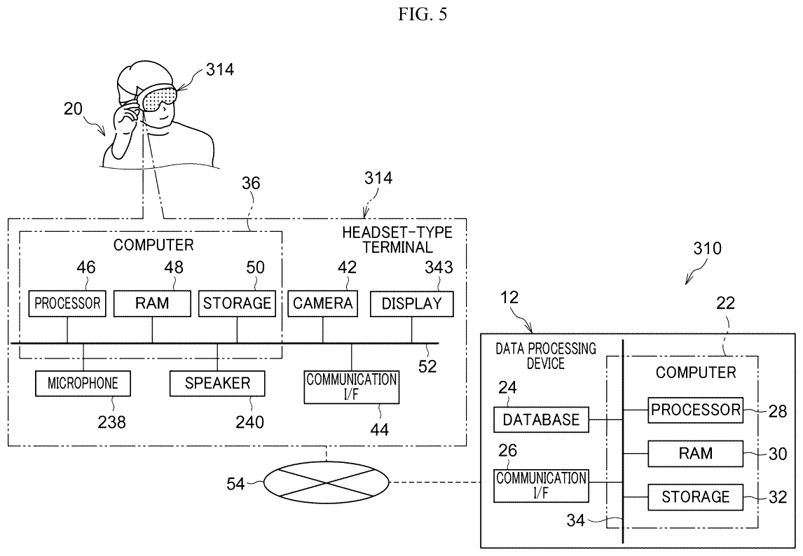

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

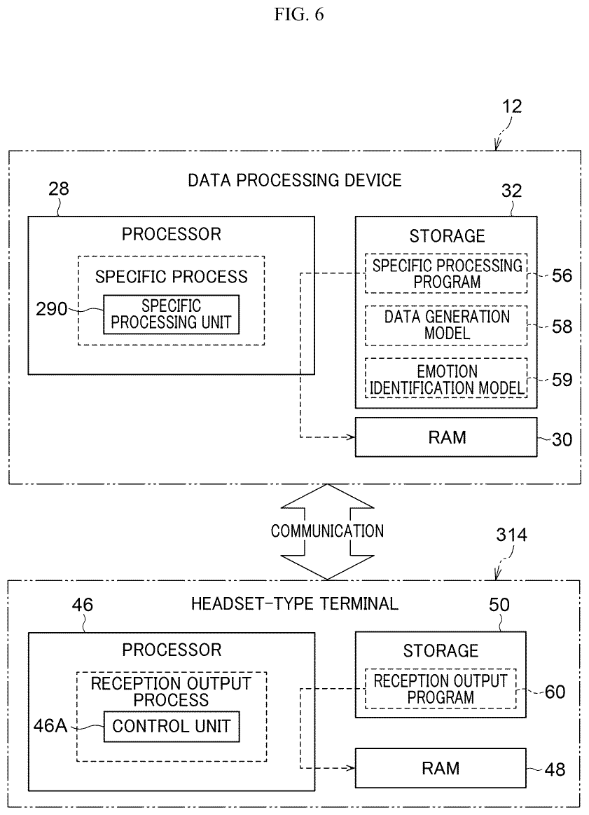

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

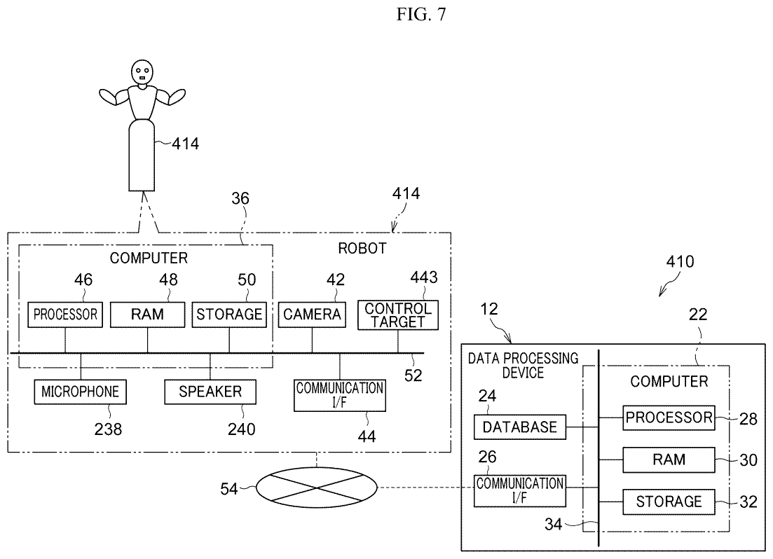

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

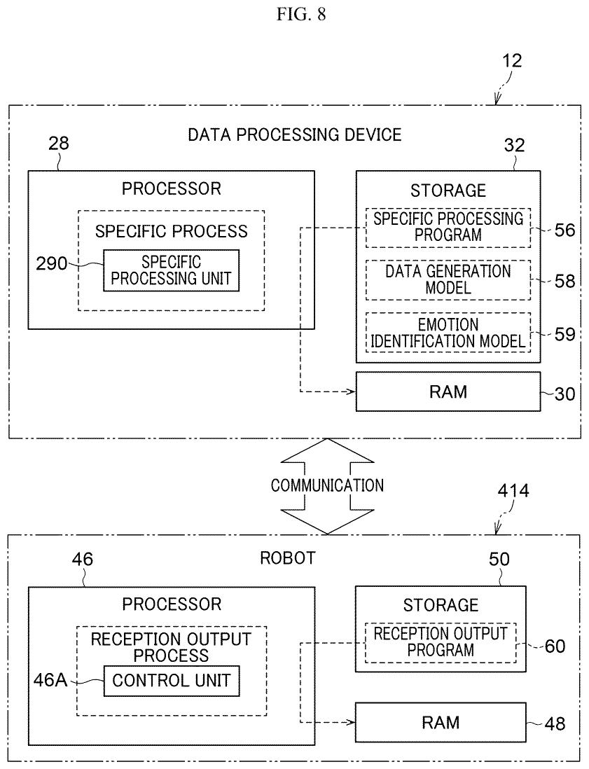

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

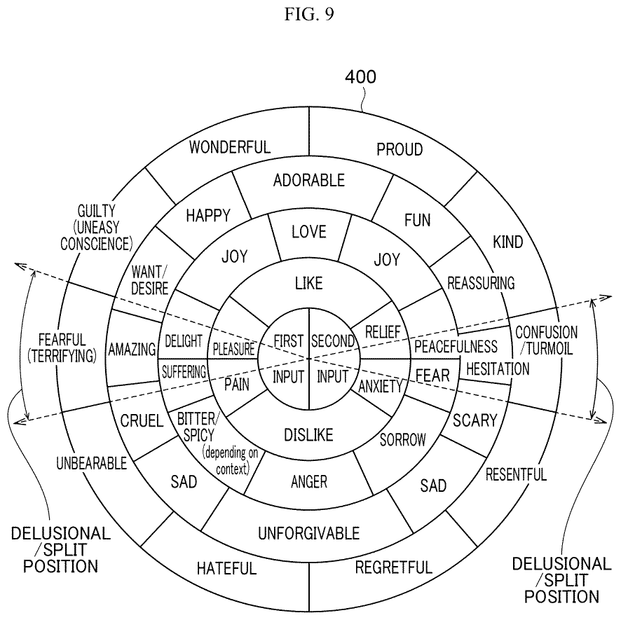

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

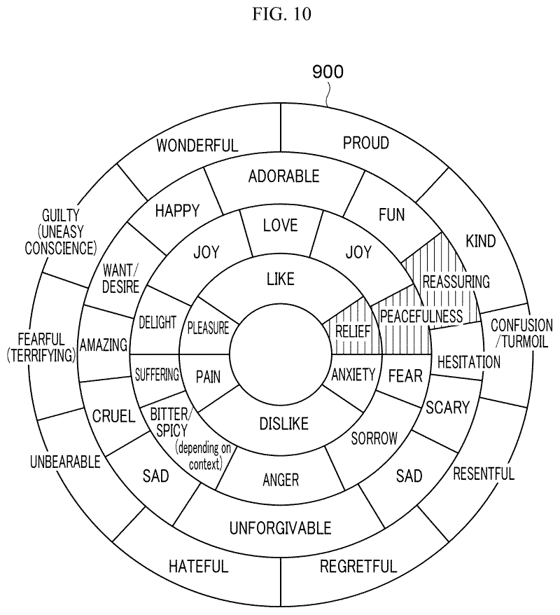

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire current meteorological information from an external meteorological information providing apparatus based on input information received from a user terminal, the input information including location information of a user, and normalize the acquired meteorological information as meteorological condition data including at least temperature, presence or absence of precipitation, humidity, and wind speed,
generate a prompt sentence as generation text by summarizing the meteorological condition data into a meteorological description text, combining the meteorological description text with an inquiry sentence included in the input information, and further adding response conditions and constraint conditions so that the prompt sentence has a structured text format suitable for a generative AI model,
input the prompt sentence into an external natural language generative information processing model and acquire, from the natural language generative information processing model, natural language text relating to a clothing proposal based on the meteorological condition data and user attribute information,
store attribute information relating to garments or accessories owned by the user as structured data including at least type, color, material, seasonal suitability, and usage history in a storage apparatus, and manage the structured data in association with user identification information, include the structured data acquired from the storage apparatus in the prompt sentence and instruct the natural language generative information processing model to generate a coordination proposal using only the garments or accessories included in the structured data, select product data acquired from a commercial transaction information processing apparatus based on generalized attribute information including at least price range, functional characteristics, color, style attributes, and size attributes, summarize the selected product data, incorporate the summarized product data into the prompt sentence, and instruct the natural language generative information processing model to generate a purchase candidate proposal taking the product data into account,
analyze the natural language text output from the natural language generative information processing model to extract proposed garment items or product candidates and format the extracted items as output data that can be presented to the user terminal, and
analyze additional input from the user, past inquiry history, owned garment information, and product selection history, and update configuration elements of the prompt sentence and selection conditions for the product data for use in subsequent processing.

### (Supplementary 2)

The system according to supplementary 1,
wherein the processor is configured to
store past purchase history information and browsing history information of the user as behavior history data, perform statistical analysis or machine learning based feature extraction processing on the behavior history data to generate preference parameters, and reflect the preference parameters in the prompt sentence and in selection conditions for the product data.

### (Supplementary 3)

The system according to supplementary 1,
wherein the processor is configured to
receive text input from the user via an input/output interface, convert the text input into emotion state data by emotion information estimation processing, and include the emotion state data in the prompt sentence so as to adjust content or expression style of the clothing proposal generated by the natural language generative information processing model.

### Application Example 1

### (Supplementary 1)

A system comprising a processor,
wherein the processor is configured to
acquire current location information of a user and, using a predetermined communication protocol, acquire weather data corresponding to the current location information from an external weather information providing apparatus,
generate a prompt sentence to be input to a generative artificial intelligence model, based on the weather data and information acquired from an information storage apparatus that stores clothing information owned by the user and preference information of the user,
input the prompt sentence to the generative artificial intelligence model and generate clothing recommendation information, suitable for a weather condition and for clothing owned by the user, from the generative artificial intelligence model,
determine candidate product information to be presented to the user by filtering product information acquired from an external product providing apparatus, based on a clothing type and an attribute included in the clothing recommendation information,
generate in-store clothing recommendation information, based on store identification information acquired by reading a code installed in a store by a user terminal and inventory information of the store, and by associating the inventory information with the clothing recommendation information,
acquire input information and emotion information of the user via an input interface and a sensor device, dynamically modify the prompt sentence according to an emotion analysis result obtained by emotion analysis processing and according to the weather data, and generate updated clothing recommendation information by re-inputting the modified prompt sentence to the generative artificial intelligence model, and
transmit the clothing recommendation information and the candidate product information to the user terminal and cause the user terminal to display the clothing recommendation information and the candidate product information.

### (Supplementary 2)

The system according to supplementary 1,
wherein the processor is configured to
acquire purchase history information and browsing history information of the user from the information storage apparatus, extract a preference tendency and a style tendency of the user by data analysis processing, and automatically adjust generation content of the prompt sentence and filtering conditions for the candidate product information from the external product providing apparatus, based on the extracted preference tendency and the extracted style tendency.

### (Supplementary 3)

The system according to supplementary 1,
wherein the processor is configured to
acquire chat-type text input from the user terminal as dialog information, include the dialog information in the prompt sentence, generate a composite context by combining the dialog information, the weather data, the clothing information owned by the user, the preference information of the user, and the emotion analysis result, and input the composite context to the generative artificial intelligence model to generate, in real time for each user, personalized clothing recommendation information.

### Example 2

### (Supplementary 1)

A system comprising a processor,
wherein the processor is configured to
receive item information representing clothing possessed by a user from a terminal, store the item information in a storage region of a storage device on a per-user basis, and register the item information in a structured manner based on higher-level classifications of attribute information included in the item information,
obtain, from the terminal, a question expressed in natural language and input by the user, analyze the question to extract information indicating at least a color, a category, a use, a season, and a scene, and search the storage region for clothing item information possessed by the user and related to the extracted information,
convert the searched clothing item information into text-form summarized information including at least color information, classification information, and use information, and generate a prompt sentence for input to a generative natural language processing model by combining the summarized information with contents of the question and constraint conditions,
input the generated prompt sentence into an internal or external generative natural language processing model, cause the generative natural language processing model to generate text data representing outfit proposals within a range of clothing item information possessed by the user, and acquire the generated text data,
analyze descriptions of clothing items included in the acquired text data, compare the descriptions with the clothing item information stored in the storage region, convert each outfit proposal into structured data in which clothing items included in the outfit proposal are associated with clothing identification information, and add image information and attribute information to the structured data based on the clothing identification information,
generate presentation data based on the structured data, the presentation data including text information and image information representing the outfit proposals, and transmit the presentation data to the terminal so that the outfit proposals are presentable in a visual or textual form on the terminal, and
obtain evaluation information or preference information from the user via the terminal, store the evaluation information or the preference information in the storage region, and reflect the evaluation information or the preference information in at least one of a processing for generating the prompt sentence and a processing for searching the clothing item information so as to utilize the evaluation information or the preference information in generation of subsequent outfit proposals.

### (Supplementary 2)

The system according to supplementary 1,
wherein the processor is configured to
analyze a usage history, a browsing history, or a preference history of the user by statistical analysis or data mining, and, based on a result of the analysis, adjust at least one of a selection criterion for clothing item information to be included in the prompt sentence and a priority of the outfit proposals represented in the text data.

### (Supplementary 3)

The system according to supplementary 1,
wherein the processor is configured to
acquire product information related to clothing items from an online information source,
combine the product information with the clothing item information and the preference information of the user stored in the storage region to include the product information in the prompt sentence, and cause the generative natural language processing model to generate the outfit proposals using, as candidates, both the clothing items possessed by the user and the clothing items represented by the product information.

### Application Example 2

### (Supplementary 1)

A system comprising a processor,
wherein the processor is configured to
acquire location information and time information of a user from a terminal apparatus, acquire weather information corresponding to the location information from an external information providing apparatus, and determine a combination of clothing suitable for the user based on the weather information,
receive clothing information input by the user through the terminal apparatus, register the clothing information as clothing management information in a storage device, and extract combination candidates of clothing owned by the user based on the clothing management information,
obtain past purchase history information and browsing history information of the user as history record information from the storage device, analyze the history record information by using a statistical processing method and a machine learning method, and generate user attribute information indicating preference information and style information of the user,
obtain product information from an external information source, filter the product information based on the user attribute information and the weather information, and select candidate clothing information to be presented to the user,
receive input text information of the user and image information or audio information acquired by the terminal apparatus, input the input text information and the image information or the audio information to an emotion analysis processing unit to obtain emotion state information,
store the emotion state information as emotion record information, and adjust a priority of the combination candidates of clothing and a priority of the candidate clothing information in accordance with the emotion state information,
generate a prompt sentence to be input to a generative artificial intelligence model based on the weather information, the clothing management information, the user attribute information, the candidate clothing information, and the emotion state information, transmit the prompt sentence to the generative artificial intelligence model, obtain proposal information expressed in natural language from the generative artificial intelligence model, and generate clothing proposal information to be presented to the user based on the proposal information,
transmit the clothing proposal information to the terminal apparatus and cause the terminal apparatus to display the clothing proposal information as image information and text information, and
obtain preference information and purchase information of the user with respect to the clothing proposal information as feedback information, store the feedback information in association with the emotion record information as learning data, and update the user attribute information and a process for generating the prompt sentence based on the learning data.

### (Supplementary 2)

The system according to supplementary 1,
wherein the processor is configured to analyze a correspondence between the proposal information obtained from the generative artificial intelligence model and the clothing management information and the product information, identify clothing elements included in the proposal information, specify clothing management information and product information corresponding to the clothing elements, generate coordination image data in a virtual display space by using the specified clothing management information and product information, and
output the coordination image data to the terminal apparatus such that a combination of clothing owned by the user and new products can be visually confirmed in the virtual display space.

### (Supplementary 3)

The system according to supplementary 1,
wherein the processor is configured to store dialogue information sequentially input by the user through the terminal apparatus and evaluation information of the user regarding the clothing proposal information as session information, generate a new prompt sentence based on past prompt sentences and past proposal results including the session information, input the new prompt sentence to the generative artificial intelligence model, and perform continuous clothing proposal taking into account a dialogue history with the user.

What is claimed is:

1. A system comprising:
circuitry configured to:
acquire, via a communication interface coupled to a packet-switched network, location data from a terminal device, obtain environmental condition data corresponding to the location data from an external information providing apparatus, and normalize the environmental condition data as structured condition data;
store and manage, in a storage device, structured attribute data for user-owned items in association with user identification data;
generate a prompt data structure by combining a summary of the structured condition data with a user query received from the terminal device, embedding the structured attribute data for the user-owned items, and including response constraint conditions;
transmit the prompt data structure to a generative neural network model and obtain natural language output text representing a coordination proposal constrained to the structured attribute data;
select and summarize external product data obtained from an external product information apparatus based on generalized attribute data, and embed the summarized product data into the prompt data structure to cause the generative neural network model to generate candidate product proposals;
parse the natural language output text to extract proposed item references and format output data for presentation at the terminal device; and
analyze user additional input data, query history data, owned item data, and product selection history data to update configuration elements of the prompt data structure and selection conditions for the external product data.

2. The system according to claim 1,
wherein the environmental condition data comprises at least temperature data, precipitation data, humidity data, and wind speed data, and the circuitry normalizes the environmental condition data into a standardized internal representation for programmatic processing and prompt generation.

3. The system according to claim 1,
wherein the circuitry is configured to acquire item attribute data from the terminal device, register the item attribute data in the storage device on a per-user basis in a structured form using higher-level attribute classifications comprising at least color data, category data, use-context data, and season data.

4. The system according to claim 3,
wherein the circuitry receives a natural language query from the terminal device, analyzes the query to extract attribute conditions comprising at least color, category, use, season, and scene, searches the storage device for item data matching the extracted attribute conditions, converts matching item data into summarized text-form representations, and programmatically generates the prompt data structure by combining the summarized representations with the query and system-level constraint conditions.

5. The system according to claim 4,
wherein the circuitry analyzes the natural language output text to detect references to specific items, maps the detected references to item identification data stored in the storage device, constructs structured data in which each coordination proposal is associated with one or more item identification entries, and augments the structured data with corresponding image data and attribute data retrieved from the storage device.

6. The system according to claim 5,
wherein the circuitry acquires evaluation data or preference data from the terminal device, stores the evaluation data or preference data in the storage device, and updates at least one of the searching of the item data and the generation of the prompt data structure based on the stored evaluation data to iteratively improve subsequent coordination proposals.

7. The system according to claim 1,
wherein the circuitry is configured to receive store identification data obtained by the terminal device reading a code installed at a physical location, acquire inventory data from an inventory information source associated with the store identification data, and associate the inventory data with the coordination proposal to generate location-specific coordination data.

8. The system according to claim 1,
wherein the circuitry is configured to acquire input data and sensor data of a user via an input interface and a sensor device of the terminal device, perform emotion analysis processing on at least one of text input data, image data, and audio data to obtain an emotion analysis result, and dynamically modify the prompt data structure according to the emotion analysis result and the structured condition data.

9. The system according to claim 8,
wherein the circuitry re-transmits the modified prompt data structure to the generative neural network model to generate updated coordination proposal data reflecting the emotion analysis result, and transmits the updated coordination proposal data to the terminal device.

10. The system according to claim 8,
wherein the circuitry stores the emotion analysis result as emotion record data in the storage device, adjusts a priority of coordination candidates and a priority of candidate product data in accordance with the emotion record data, and generates the prompt data structure incorporating the adjusted priorities.

11. The system according to claim 1,
wherein the circuitry is configured to obtain past interaction history data and browsing history data of the user from the storage device, analyze the history data by using at least one of a statistical processing method and a machine learning method, and generate user attribute data indicating preference data and style data of the user for inclusion in the prompt data structure.

12. The system according to claim 11,
wherein the circuitry filters the external product data based on the user attribute data and the structured condition data to select candidate product data, and embeds the candidate product data into the prompt data structure for the generative neural network model.

13. The system according to claim 11,
wherein the circuitry obtains feedback data from the terminal device with respect to the coordination proposal, stores the feedback data in association with the emotion record data as learning data, and updates the user attribute data and the prompt data structure generation process based on the learning data.

14. The system according to claim 1,
wherein the circuitry analyzes a correspondence between the natural language output text and the structured attribute data and the external product data, identifies item elements included in the output text, and specifies matching item identification data or product identification data stored in the storage device.

15. The system according to claim 1,
wherein the response constraint conditions in the prompt data structure comprise at least one of a constraint limiting proposed items to items present in the structured attribute data, a constraint specifying a maximum number of proposed items, and a constraint specifying an environmental condition compatibility requirement.

16. The system according to claim 1,
wherein the generalized attribute data used for selecting the external product data comprises at least one of category classification data, price range data, and compatibility data derived from the structured attribute data for the user-owned items.

17. The system according to claim 1,
wherein the circuitry generates presentation data comprising text data and image data associated with each proposed item and transmits the presentation data to the terminal device, and the presentation data includes for each proposed item at least an item identifier, an attribute summary, and a source indicator distinguishing user-owned items from external product items.

18. A system comprising:
a communication interface coupled to a packet-switched network and configured to communicate with a terminal device;
a storage device storing a generative neural network model obtained by deep learning on a neural network; and
circuitry configured to:
acquire, via the communication interface, location data from the terminal device, obtain environmental condition data from an external information providing apparatus corresponding to the location data, and normalize the environmental condition data as structured condition data;
store structured attribute data for user-owned items in the storage device in association with user identification data;
generate a prompt data structure by combining the structured condition data with a user query received from the terminal device and the structured attribute data, and transmit the prompt data structure to the generative neural network model to obtain a coordination proposal constrained to the structured attribute data;
select external product data based on generalized attribute data derived from the structured attribute data and embed the external product data into the prompt data structure to obtain candidate product proposals from the generative neural network model;
parse output text from the generative neural network model to extract proposed item references and format output data for transmission to the terminal device via the communication interface and the packet-switched network; and
update configuration elements of the prompt data structure and selection conditions for the external product data based on user interaction history data stored in the storage device.

19. The system according to claim 18,
wherein the circuitry is configured to perform emotion analysis on user sensor data received from the terminal device, dynamically modify the prompt data structure based on an emotion analysis result, and re-transmit the modified prompt data structure to the generative neural network model to obtain updated coordination proposal data.

20. A method performed by circuitry of a system comprising a communication interface coupled to a packet-switched network and a storage device storing a generative neural network model obtained by deep learning on a neural network, the method comprising:
acquiring, via the communication interface, location data from a terminal device, obtaining environmental condition data from an external information providing apparatus corresponding to the location data, and normalizing the environmental condition data as structured condition data;
storing structured attribute data for user-owned items in the storage device in association with user identification data;
generating a prompt data structure by combining the structured condition data with a user query received from the terminal device and the structured attribute data, and transmitting the prompt data structure to the generative neural network model to obtain a coordination proposal constrained to the structured attribute data;
selecting external product data based on generalized attribute data derived from the structured attribute data and embedding the external product data into the prompt data structure to obtain candidate product proposals from the generative neural network model;
parsing output text from the generative neural network model to extract proposed item references and formatting output data for transmission to the terminal device via the communication interface and the packet-switched network; and
updating configuration elements of the prompt data structure and selection conditions for the external product data based on user interaction history data.
